(19) United States
(12) Patent Application Publication
(10) Pub. No.: US 2024/0242436 A1
(43) Pub. Date: Jul. 18, 2024

(54) Voxelization Enhancement of TriSoup Triangles

(71) Applicant: Comcast Cable Communications, LLC, Philadelphia, PA (US)

(72) Inventor: Sébastien Lasserre, Thorigné-Fouillard (FR)

(21) Appl. No.: 18/413,862

(22) Filed: Jan. 16, 2024

Related U.S. Application Data
(60) Provisional application No. 63/439,274, filed on Jan. 16, 2023.

(51) Int. Cl. G06T 17/20; G06T 15/06

(52) U.S. Cl. CPC G06T 17/20; G06T 15/06; G06T 2210/21; G06T 2210/52; G06T 2210/56

(57) ABSTRACT

TriSoup triangles may be used to model a point cloud. Some points may be missed when modeling the point cloud using TriSoup triangles. Missed points may be recovered by identifying points that are contained within a thickness of a TriSoup triangle (e.g., a volumetric area above and below the TriSoup triangle). The recovered points found within a thickness of the TriSoup triangles may be voxelized to ensure continuity of the triangle-based modeling between TriSoup triangles.

### CROSS-REFERENCE TO RELATED APPLICATIONS

The application claims the benefit of U.S. Provisional Application No. 63/439,274 filed on Jan. 16, 2023. The above-referenced application is hereby incorporated by reference in its entirety.

### BACKGROUND

An object or scene may be described using volumetric visual data consisting of a series of points. The points may be stored as a point cloud format that includes a collection of points in three-dimensional space. As point clouds can get quite large in data size, transmitting and processing point cloud data may need a data compression scheme that is specifically designed with respect to the unique characteristics of point cloud data.

### SUMMARY

The following summary presents a simplified summary of certain features. The summary is not an extensive overview and is not intended to identify key or critical elements.

Modeling a geometry of points may use sets of triangles as local models (e.g., a triangle soup (TriSoup) method). A triangle may be voxelized by determining voxels that are within the triangle. A ray may be used, for example, to determine whether a voxel is within a triangle. During voxelization occupied voxels may be missed in models that approximate occupied voxels. To provide continuity of the triangles used for this TriSoup method of modeling, the vertices of the triangle may need to be quantized. Additional rays may be used to determine voxels at vertices that may have been missed by using a single ray. As the number of rays increase, however, rendering speeds may be reduced. A single ray and a vector may be used to determine voxels within a thickness around the triangle without the corresponding decrease in rendering speeds associated with using multiple rays. The voxels may be determined by adding and/or subtracting a vector to an intersection point between the triangle and the ray.

These and other features and advantages are described in greater detail below.

### BRIEF DESCRIPTION OF THE DRAWINGS

Examples of several of the various embodiments of the present disclosure are described herein with reference to the drawings.

FIG. 1 shows an example point cloud coding system.

FIG. 2 shows an example Morton order.

FIG. 3 shows an example scanning order.

FIG. 4 shows an example neighborhood of cuboids with already-coded occupancy bits.

FIG. 5 shows an example of a dynamic reduction function DR that may be used in dynamic Optimal Binary Coders with Update on the Fly (OBUF).

FIG. 6 shows an example method for coding occupancy of a cuboid using dynamic OBUF.

FIG. 7 shows an example of an occupied cuboid.

FIG. 8A shows an example cuboid corresponding to a TriSoup node.

FIG. 8B shows an example refinement to the TriSoup model.

FIG. 9 shows an example of voxelization.

FIGS. 10A and 10B show an example of approximating a TriSoup triangle of occupied voxels.

FIG. 11 shows an example of barycentric coordinates of a point relative to a TriSoup triangle.

FIGS. 12A and 12B show examples of a halo method.

FIG. 13 shows an example of a halo method used for a TriSoup triangle.

FIG. 14 shows an example of a fine-ray-launch method.

FIG. 15 shows an example of using a halo method and a fine-ray-launch method.

FIG. 16 shows an example of enhancing voxelization of a TriSoup triangle.

FIG. 17 shows an example of enhancing voxelization of a TriSoup triangle.

FIGS. 18A and 18B show example methods of coding a point cloud from TriSoup triangles.

FIG. 19 shows a block diagram of an example computer system in which examples of the present disclosure may be implemented.

FIG. 20 shows example elements of a computing device that may be used to implement any of the various devices described herein.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of point cloud or point cloud sequence encoding or decoding systems. More particularly, the technology disclosed herein may relate to point cloud compression as used in encoding and/or decoding devices and/or systems.

At least some visual data may describe an object or scene using a series of points. Each point may comprise a position in two dimensions (x and y) and one or more optional attributes like color. Volumetric visual data may add another positional dimension to these visual data. For example, volumetric visual data may describe an object or scene using a series of points that each may comprise a position in three dimensions (x, y, and z) and one or more optional attributes like color, reflectance, time stamp, etc. Volumetric visual data may provide a more immersive way to experience visual data, for example, compared to the at least some visual data. For example, an object or scene described by volumetric visual data may be viewed from any (or multiple) angles, whereas the at least some visual data may generally only be viewed from the angle in which it was captured or rendered.

Volumetric visual data may be used in many applications, including augmented reality (AR), virtual reality (VR), and mixed reality (MR). Sparse volumetric visual data may be used in the automotive industry for the representation of three-dimensional (3D) maps (e.g., cartography) or as input to assisted driving systems. In the case of assisted driving systems, volumetric visual data may be typically input to driving decision algorithms. Volumetric visual data may be used to store valuable objects in digital form. In applications for preserving cultural heritage, a goal may be to keep a representation of objects that may be threatened by natural disasters. For example, statues, vases, and temples may be entirely scanned and stored as volumetric visual data having several billions of samples. This use-case for volumetric visual data may be particularly relevant for valuable objects in locations where earthquakes, tsunamis and typhoons are frequent. Volumetric visual data may take the form of a volumetric frame. The volumetric frame may describe an object or scene captured at a particular time instance. Volumetric visual data may take the form of a sequence of volumetric frames (referred to as a volumetric sequence or volumetric video). The sequence of volumetric frames may describe an object or scene captured at multiple different time instances.

Volumetric visual data may be stored in various formats. One format for storing volumetric visual data may be point clouds. A point cloud may comprise a collection of points in 3D space. Each point in a point cloud may comprise geometry information that may indicate the point's position in 3D space. For example, the geometry information may indicate the point's position in 3D space, for example, using three Cartesian coordinates (x, y, and z) and/or using spherical coordinates (r, phi, theta) (e.g., if acquired by a rotating sensor). The positions of points in a point cloud may be quantized according to a space precision. The space precision may be the same or different in each dimension. The quantization process may create a grid in 3D space. One or more points residing within each sub-grid volume may be mapped to the sub-grid center coordinates, referred to as voxels. A voxel may be considered as a 3D extension of pixels corresponding to the 2D image grid coordinates. A point in a point cloud may comprise one or more types of attribute information. Attribute information may indicate a property of a point's visual appearance. For example, attribute information may indicate a texture (e.g., color) of the point, a material type of the point, transparency information of the point, reflectance information of the point, a normal vector to a surface of the point, a velocity at the point, an acceleration at the point, a time stamp indicating when the point was captured, or a modality indicating how the point was captured (e.g., running, walking, or flying). A point in a point cloud may comprise light field data in the form of multiple view-dependent texture information. Light field data may be another type of optional attribute information.

The points in a point cloud may describe an object or a scene. For example, the points in a point cloud may describe the external surface and/or the internal structure of an object or scene. The object or scene may be synthetically generated by a computer. The object or scene may be generated from the capture of a real-world object or scene. The geometry information of a real-world object or a scene may be obtained by 3D scanning and/or photogrammetry. 3D scanning may include different types of scanning, for example, laser scanning, structured light scanning, and/or modulated light scanning. 3D scanning may obtain geometry information. 3D scanning may obtain geometry information, for example, by moving one or more laser heads, structured light cameras, and/or modulated light cameras relative to an object or scene being scanned. Photogrammetry may obtain geometry information. Photogrammetry may obtain geometry information, for example, by triangulating the same feature or point in different spatially shifted 2D photographs. Point cloud data may take the form of a point cloud frame. The point cloud frame may describe an object or scene captured at a particular time instance. Point cloud data may take the form of a sequence of point cloud frames. The sequence of point cloud frames may be referred to as a point cloud sequence or point cloud video. The sequence of point cloud frames may describe an object or scene captured at multiple different time instances.

The data size of a point cloud frame or point cloud sequence may be excessive (e.g., too large) for storage and/or transmission in many applications. For example, a single point cloud may comprise over a million points or even billions of points. Each point may comprise geometry information and one or more optional types of attribute information. The geometry information of each point may comprise three Cartesian coordinates (x, y, and z) and/or spherical coordinates (r, phi, theta) that may be each represented, for example, using at least 10 bits per component or 30 bits in total. The attribute information of each point may comprise a texture corresponding to a plurality of (e.g., three) color components (e.g., R, G, and B color components). Each color component may be represented, for example, using 8-10 bits per component or 24-30 bits in total. For example, a single point may comprise at least 54 bits of information, with at least 30 bits of geometry information and at least 24 bits of texture. If a point cloud frame includes a million such points, each point cloud frame may require 54 million bits or 54 megabits to represent. For dynamic point clouds that change over time, at a frame rate of 30 frames per second, a data rate of 1.32 gigabits per second may be required to send (e.g., transmit) the points of the point cloud sequence. Raw representations of point clouds may require a large amount of data, and the practical deployment of point-cloud-based technologies may need compression technologies that enable the storage and distribution of point clouds with a reasonable cost.

Encoding may be used to compress and/or reduce the data size of a point cloud frame or point cloud sequence to provide for more efficient storage and/or transmission. Decoding may be used to decompress a compressed point cloud frame or point cloud sequence for display and/or other forms of consumption (e.g., by a machine learning based device, neural network-based device, artificial intelligence-based device, or other forms of consumption by other types of machine-based processing algorithms and/or devices). Compression of point clouds may be lossy (introducing differences relative to the original data) for the distribution to and visualization by an end-user, for example, on AR or VR glasses or any other 3D-capable device. Lossy compression may allow for a high ratio of compression but may imply a trade-off between compression and visual quality perceived by an end-user. Other frameworks, for example, frameworks for medical applications or autonomous driving, may require lossless compression to avoid altering the results of a decision obtained, for example, based on the analysis of the sent (e.g., transmitted) and decompressed point cloud frame.

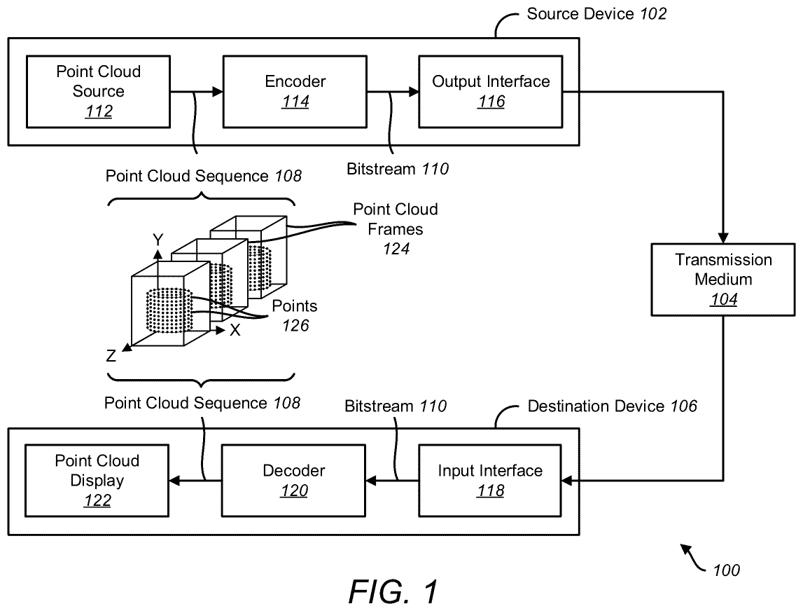

FIG. 1 shows an example point cloud coding (e.g., encoding and/or decoding) system 100. Point cloud coding system 100 may comprise a source device 102, a transmission medium 104, and a destination device 106. Source device 102 may encode a point cloud sequence 108 into a bitstream 110 for more efficient storage and/or transmission. Source device 102 may store and/or send (e.g., transmit) bitstream 110 to destination device 106 via transmission medium 104. Destination device 106 may decode bitstream 110 to display point cloud sequence 108 or for other forms of consumption (e.g., further analysis, storage, etc.). Destination device 106 may receive bitstream 110 from source device 102 via a storage medium or transmission medium 104. Source device 102 and destination device 106 may include any number of different devices. Source device 102 and destination device 106 may include, for example, a cluster of interconnected computer systems acting as a pool of seamless resources (also referred to as a cloud of computers or cloud computer), a server, a desktop computer, a laptop computer, a tablet computer, a smart phone, a wearable device, a television, a camera, a video gaming console, a set-top box, a video streaming device, a vehicle (e.g., an autonomous vehicle), or a head-mounted display. A head-mounted display may allow a user to view a VR, AR, or MR scene and adjust the view of the scene, for example, based on movement of the user's head. A head-mounted display may be connected (e.g., tethered) to a processing device (e.g., a server, a desktop computer, a set-top box, or a video gaming console) or may be fully self-contained.

A source device 102 may comprise a point cloud source 112, an encoder 114, and an output interface 116. A source device 102 may comprise a point cloud source 112, an encoder 114, and an output interface 116, for example, to encode point cloud sequence 108 into a bitstream 110. Point cloud source 112 may provide (e.g., generate) point cloud sequence 108, for example, from a capture of a natural scene and/or a synthetically generated scene. A synthetically generated scene may be a scene comprising computer generated graphics. Point cloud source 112 may comprise one or more point cloud capture devices, a point cloud archive comprising previously captured natural scenes and/or synthetically generated scenes, a point cloud feed interface to receive captured natural scenes and/or synthetically generated scenes from a point cloud content provider, and/or a processor(s) to generate synthetic point cloud scenes. The point cloud capture devices may include, for example, one or more laser scanning devices, structured light scanning devices, modulated light scanning devices, and/or passive scanning devices.

Point cloud sequence 108 may comprise a series of point cloud frames 124 (e.g., an example shown in FIG. 1). A point cloud frame may describe an object or scene captured at a particular time instance. Point cloud sequence 108 may achieve the impression of motion by using a constant or variable time to successively present point cloud frames 124 of point cloud sequence 108. A point cloud frame may comprise a collection of points (e.g., voxels) 126 in 3D space. Each point 126 may comprise geometry information that may indicate the point's position in 3D space. The geometry information may indicate, for example, the point's position in 3D space using three Cartesian coordinates (x, y, and z). One or more of points 126 may comprise one or more types of attribute information. Attribute information may indicate a property of a point's visual appearance. For example, attribute information may indicate, for example, a texture (e.g., color) of a point, a material type of a point, transparency information of a point, reflectance information of a point, a normal vector to a surface of a point, a velocity at a point, an acceleration at a point, a time stamp indicating when a point was captured, a modality indicating how a point was captured (e.g., running, walking, or flying), etc. One or more of points 126 may comprise, for example, light field data in the form of multiple view-dependent texture information. Light field data may be another type of optional attribute information. Color attribute information of one or more of points 126 may comprise a luminance value and two chrominance values. The luminance value may represent the brightness (e.g., luma component, Y) of the point. The chrominance values may respectively represent the blue and red components of the point (e.g., chroma components, Cb and Cr) separate from the brightness. Other color attribute values may be represented, for example, based on different color schemes (e.g., an RGB or monochrome color scheme).

Encoder 114 may encode point cloud sequence 108 into a bitstream 110. To encode point cloud sequence 108, encoder 114 may use one or more lossless or lossy compression techniques to reduce redundant information in point cloud sequence 108. To encode point cloud sequence 108, encoder 114 may use one or more prediction techniques to reduce redundant information in point cloud sequence 108. Redundant information is information that may be predicted at a decoder 120 and may not be needed to be sent (e.g., transmitted) to decoder 120 for accurate decoding of point cloud sequence 108. For example, Motion Picture Expert Group (MPEG) introduced a geometry-based point cloud compression (G-PCC) standard (ISO/IEC standard 23090-9: Geometry-based point cloud compression). G-PCC specifies the encoded bitstream syntax and semantics for transmission and/or storage of a compressed point cloud frame and the decoder operation for reconstructing the compressed point cloud frame from the bitstream. During standardization of G-PCC, a reference software (ISO/IEC standard 23090-21: Reference Software for G-PCC) was developed to encode the geometry and attribute information of a point cloud frame. To encode geometry information of a point cloud frame, the G-PCC reference software encoder may perform voxelization. The G-PCC reference software encoder may perform voxelization, for example, by quantizing positions of points in a point cloud. Quantizing positions of points in a point cloud may create a grid in 3D space. The G-PCC reference software encoder may map the points to the center coordinates of the sub-grid volume (e.g., voxel) that their quantized locations reside in. The G-PCC reference software encoder may perform geometry analysis using an occupancy tree to compress the geometry information. The G-PCC reference software encoder may entropy encode the result of the geometry analysis to further compress the geometry information. To encode attribute information of a point cloud, the G-PCC reference software encoder may use a transform tool, such as Region Adaptive Hierarchical Transform (RAHT), the Predicting Transform, and/or the Lifting Transform. The Lifting Transform may be built on top of the Predicting Transform. The Lifting Transform may include an extra update/lifting step. The Lifting Transform and the Predicting Transform may be referred to as Predicting/Lifting Transform or pred lift. Encoder 114 may operate in a same or similar manner to an encoder provided by the G-PCC reference software.

Output interface 116 may be configured to write and/or store bitstream 110 onto transmission medium 104. The bitstream 110 may be sent (e.g., transmitted) to destination device 106. In addition or alternatively, output interface 116 may be configured to send (e.g., transmit), upload, and/or stream bitstream 110 to destination device 106 via transmission medium 104. Output interface 116 may comprise a wired and/or wireless transmitter configured to send (e.g., transmit), upload, and/or stream bitstream 110 according to one or more proprietary, open-source, and/or standardized communication protocols. The one or more proprietary, open-source, and/or standardized communication protocols may include, for example, Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, Wireless Application Protocol (WAP) standards, and/or any other communication protocol.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one or more networks (e.g., the Internet) or file server(s) configured to store and/or send (e.g., transmit) encoded video data.

Destination device 106 may decode bitstream 110 into point cloud sequence 108 for display or other forms of consumption. Destination device 106 may comprise one or more of an input interface 118, a decoder 120, and/or a point cloud display 122. Input interface 118 may be configured to read bitstream 110 stored on transmission medium 104. Bitstream 110 may be stored on transmission medium 104 by source device 102. In addition or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary, open-source, standardized communication protocols, and/or any other communication protocol. Examples of the protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Decoder 120 may decode point cloud sequence 108 from encoded bitstream 110. For example, decoder 120 may operate in a same or similar manner as a decoder provided by G-PCC reference software. Decoder 120 may decode a point cloud sequence that approximates a point cloud sequence 108. Decoder 120 may decode a point cloud sequence that approximates a point cloud sequence 108 due to, for example, lossy compression of the point cloud sequence 108 by encoder 114 and/or errors introduced into encoded bitstream 110, for example, if transmission to destination device 106 occurs.

Point cloud display 122 may display a point cloud sequence 108 to a user. The point cloud display 122 may comprise, for example, a cathode rate tube (CRT) display, a liquid crystal display (LCD), a plasma display, a light emitting diode (LED) display, a 3D display, a holographic display, a head-mounted display, or any other display device suitable for displaying point cloud sequence 108.

Point cloud coding (e.g., encoding/decoding) system 100 is presented by way of example and not limitation. Point cloud coding systems different from the point cloud coding system 100 and/or modified versions of the point cloud coding system 100 may perform the methods and processes as described herein. For example, the point cloud coding system 100 may comprise other components and/or arrangements. Point cloud source 112 may, for example, be external to source device 102. Point cloud display device 122 may, for example, be external to destination device 106 or omitted altogether (e.g., if point cloud sequence 108 is intended for consumption by a machine and/or storage device). Source device 102 may further comprise, for example, a point cloud decoder. Destination device 106 may comprise, for example, a point cloud encoder. For example, source device 102 may be configured to further receive an encoded bit stream from destination device 106. Receiving an encoded bit stream from destination device 106 may support two-way point cloud transmission between the devices.

As described herein, an encoder may quantize the positions of points in a point cloud according to a space precision, which may be the same or different in each dimension of the points. The quantization process may create a grid in 3D space. The encoder may map any points residing within each sub-grid volume to the sub-grid center coordinates, referred to as a voxel or a volumetric pixel. A voxel may be considered as a 3D extension of pixels corresponding to 2D image grid coordinates.

An encoder may represent or code a voxelized point cloud. An encoder may represent or code a voxelized point cloud, for example, using an occupancy tree. For example, the encoder may split the initial volume or cuboid containing the voxelized point cloud into sub-cuboids. The initial volume or cuboid may be referred to as a bounding box. A cuboid may be, for example, a cube. The encoder may recursively split each sub-cuboid that contains at least one point of the point cloud. The encoder may not further split sub-cuboids that do not contain at least one point of the point cloud. A sub-cuboid that contains at least one point of the point cloud may be referred to as an occupied sub-cuboid. A sub-cuboid that does not contain at least one point of the point cloud may be referred to as an unoccupied sub-cuboid. The encoder may split an occupied sub-cuboid into, for example, two sub-cuboids (to form a binary trec), four sub-cuboids (to form a quadtrec), or eight sub-cuboids (to form an octrec). The encoder may split an occupied sub-cuboid to obtain further sub-cuboids. The sub-cuboids may have the same size and shape at a given depth level of the occupancy tree. The sub-cuboids may have the same size and shape at a given depth level of the occupancy tree, for example, if the encoder splits the occupied sub-cuboid along a plane passing through the middle of edges of the sub-cuboid.

The initial volume or cuboid containing the voxelized point cloud may correspond to the root node of the occupancy tree. Each occupied sub-cuboid, split from the initial volume, may correspond to a node (of the root node) in a second level of the occupancy tree. Each occupied sub-cuboid, split from an occupied sub-cuboid in the second level, may correspond to a node (off the occupied sub-cuboid in the second level from which it was split) in a third level of the occupancy tree. The occupancy tree structure may continue to form in this manner for each recursive split iteration until, for example, some maximum depth level of the occupancy tree is reached or each occupied sub-cuboid has a volume corresponding to one voxel.

Each non-leaf node of the occupancy tree may comprise or be associated with an occupancy word representing the occupancy state of the cuboid corresponding to the node. For example, a node of the occupancy tree corresponding to a cuboid that is split into 8 sub-cuboids may comprise or be associated with a 1-byte occupancy word. Each bit (referred to as an occupancy bit) of the 1-byte occupancy word may represent or indicate the occupancy of a different one of the eight sub-cuboids. Occupied sub-cuboids may be each represented or indicated by a binary “1” in the 1-byte occupancy word. Unoccupied sub-cuboids may be each represented or indicated by a binary “0” in the 1-byte occupancy word. Occupied and un-occupied sub-cuboids may be represented or indicated by opposite 1-bit binary values (e.g., a binary “0” representing or indicating an occupied sub-cuboid and a binary “1” representing or indicating an unoccupied sub-cuboid) in the 1-byte occupancy word.

Each bit of an occupancy word may represent or indicate the occupancy of a different one of the eight sub-cuboids. Each bit of an occupancy word may represent or indicate the occupancy of a different one of the eight sub-cuboids, for example, following the so-called Morton order. For example, the least significant bit of an occupancy word may represent or indicate, for example, the occupancy of a first one of the eight sub-cuboids following the Morton order. The second least significant bit of an occupancy word may represent or indicate, for example, the occupancy of a second one of the eight sub-cuboids following the Morton order, etc.

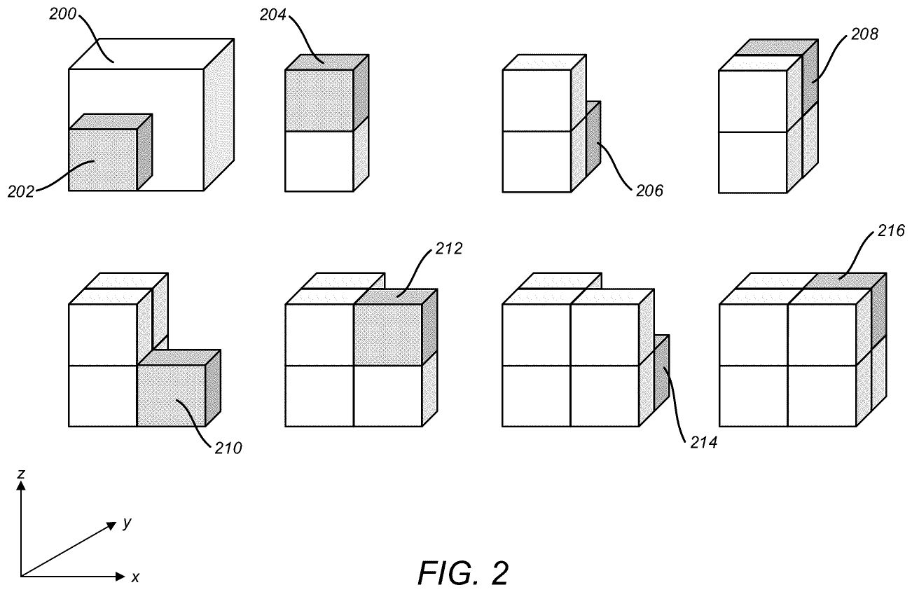

FIG. 2 shows an example Morton order. More specifically, FIG. 2 shows a Morton order of eight sub-cuboids 202-216 split from a cuboid 200. Sub-cuboids 202-216 may be labeled, for example, based on their Morton order, with child node 202 being the first in Morton order and child node 216 being the last in Morton order. The Morton order for sub-cuboids 202-216 may be a local lexicographic order in xyz.

The geometry of a voxelized point cloud may be represented by, and may be determined from, the initial volume and the occupancy words of the nodes in an occupancy trec. An encoder may send (e.g., transmit) the initial volume and the occupancy words of the nodes in the occupancy tree in a bitstream to a decoder for reconstructing the point cloud. The encoder may entropy encode the occupancy words. The encoder may entropy encode the occupancy words, for example, before sending (e.g., transmitting) the initial volume and the occupancy words of the nodes in the occupancy tree. The encoder may encode an occupancy bit of an occupancy word of a node corresponding to a cuboid. The encoder may encode an occupancy bit of an occupancy word of a node corresponding to a cuboid, for example, based on one or more occupancy bits of occupancy words of other nodes corresponding to cuboids that are adjacent or spatially close to the cuboid of the occupancy bit being encoded.

An encoder and/or a decoder may code (e.g., encode and/or decode) occupancy bits of occupancy words in sequence of a scan order. The scan order may also be referred to as a scanning order. For example, an encoder and/or a decoder may scan an occupancy tree in breadth-first order. All the occupancy words of the nodes of a given depth (e.g., level) within the occupancy tree may be scanned. All the occupancy words of the nodes of a given depth (e.g., level) within the occupancy tree may be scanned, for example, before scanning the occupancy words of the nodes of the next depth (e.g., level). Within a given depth, the encoder and/or decoder may scan the occupancy words of nodes in the Morton order. Within a given node, the encoder and/or decoder may scan the occupancy bits of the occupancy word of the node further in the Morton order.

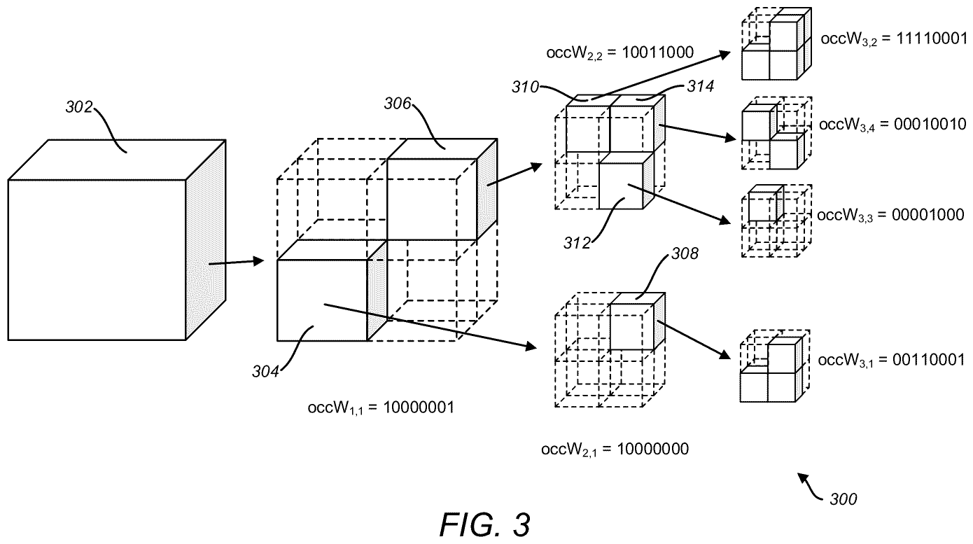

FIG. 3 shows an example scanning order. FIG. 3 shows an example scanning order (e.g., breadth-first order as described herein) for an occupancy tree 300. More specifically, FIG. 3 shows a scanning order for the first three example levels of an occupancy tree 300. In FIG. 3, a cuboid (e.g., cube) 302 corresponding to a root node of the occupancy tree 300 may be divided into eight sub-cuboids (e.g., sub-cubes). Two sub-cuboids 304 and 306 of the eight sub-cuboids may be occupied. The other six sub-cuboids of the eight sub-cuboids may be unoccupied. Following the Morton order, a first eight-bit occupancy word (e.g., occW_{1,1}) may be constructed to represent the occupancy word of the root node. An (e.g., each) occupancy bit of the first eight-bit occupancy word (e.g., occW_{1,1}) may represent or indicate the occupancy of a sub-cube of the eight sub-cuboids in the Morton order. For example, the least significant occupancy bit of the first eight-bit occupancy word occW_{1,1} may represent or indicate the occupancy of the first sub-cuboid of the eight sub-cuboids in the Morton order. The second least significant occupancy bit of the first eight-bit occupancy word occW_{1,1} may represent or indicate the occupancy of the second sub-cuboid of the eight sub-cuboids in the Morton order, etc.

Each of occupied sub-cuboids (e.g., two occupied sub-cuboids 304 and 306) may correspond to a node off the root node in a second level of an occupancy tree 300. The occupied sub-cuboids (e.g., two occupied sub-cuboids 304 and 306) may be each further split into eight sub-cuboids. For example, one of the sub-cuboids 308 of the eight sub-cuboids split from the sub-cube 304 may be occupied, and the other seven sub-cuboids may be unoccupied. Three of the sub-cuboids 310, 312, and 314 of the eight sub-cuboids split from the sub-cube 306 may be occupied, and the other five sub-cuboids of the eight sub-cuboids split from the sub-cube 306 may be unoccupied. Two second eight-bit occupancy words occW_{2,1} and occW_{2,2} may be constructed in this order to respectively represent the occupancy word of the node corresponding to the sub-cuboid 304 and the occupancy word of the node corresponding to the sub-cuboid 306.

Each of occupied sub-cuboids (e.g., four occupied sub-cuboids 308, 310, 312, and 314) may correspond to a node in a third level of an occupancy tree 300. The occupied sub-cuboids (e.g., four occupied sub-cuboids 308, 310, 312, and 314) may be each further split into eight sub-cuboids or 32 sub-cuboids in total. For example, four third level eight-bit occupancy words occW_{3,1}, occW_{3,2}, occW_{3,3} and occW_{3,4} may be constructed in this order to respectively represent the occupancy word of the node corresponding to the sub-cuboid 308, the occupancy word of the node corresponding to the sub-cuboid 310, the occupancy word of the node corresponding to the sub-cuboid 312, and the occupancy word of the node corresponding to the sub-cuboid 314.

Occupancy words of an example occupancy tree 300 may be entropy coded (e.g., entropy encoded by an encoder and/or entropy decoded by a decoder), for example, following the scanning order discussed herein (e.g., Morton order). The occupancy words of the example occupancy tree 300 may be entropy coded (e.g., entropy encoded by an encoder and/or entropy decoded by a decoder) as the succession of the seven occupancy words occW_{1,1} to occW_{3,4}, for example, following the scanning order discussed herein. The scanning order discussed herein may be a breadth-first scanning order. The occupancy word(s) of all node(s) having the same depth (or level) as a current parent node may have already been entropy coded, for example, if the occupancy word of a current child node belonging to the current parent node is being entropy coded. For example, the occupancy word(s) of all node(s) having the same depth (e.g., level) as the current child node and having a lower Morton order than the current child node may have also already been entropy coded. Part of the already coded occupancy word(s) may be used to entropy code the occupancy word of the current child node. The already coded occupancy word(s) of neighboring parent and child node(s) may be used, for example, to entropy code the occupancy word of the current child node. The occupancy bit(s) of the occupancy word having a lower Morton order than a particular occupancy bit may have also already been entropy coded and may be used to code the occupancy bit of the occupancy word of the current child node, for example, if the particular occupancy bit of the occupancy word of the current child node is being coded (e.g., entropy coded).

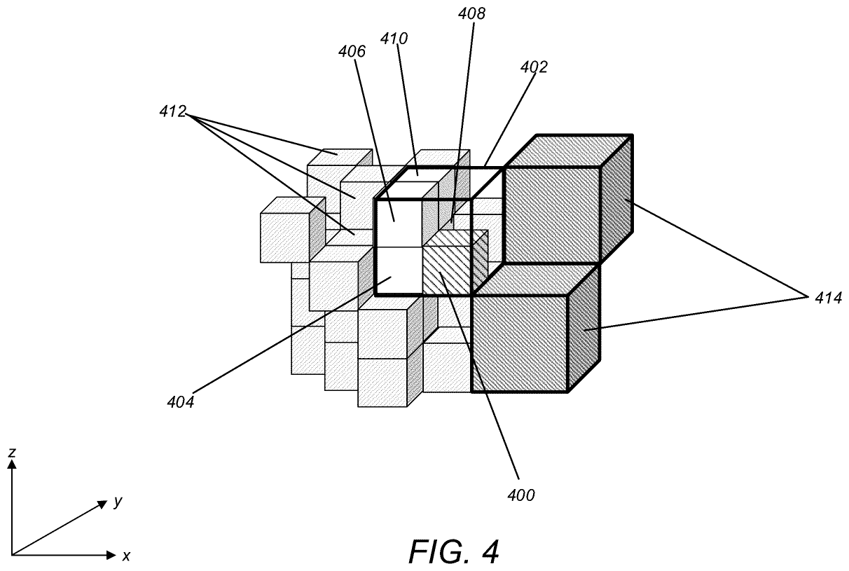

FIG. 4 shows an example neighborhood of cuboids for entropy coding the occupancy of a child cuboid. More specifically, FIG. 4 shows an example neighborhood of cuboids with already-coded occupancy bits. The neighborhood of cuboids with already-coded occupancy bits may be used to entropy code the occupancy bit of a current child cuboid 400. The neighborhood of cuboids with already-coded occupancy bits may be determined, for example, based on the scanning order of an occupancy tree representing the geometry of the cuboids in FIG. 4 as discussed herein. The neighborhood of cuboids, of a current child cuboid, may include one or more of: a cuboid adjacent to the current child cuboid, a cuboid sharing a vertex with the current child cuboid, a cuboid sharing an edge with the current child cuboid, a cuboid sharing a face with the current child cuboid, a parent cuboid adjacent to the current child cuboid, a parent cuboid sharing a vertex with the current child cuboid, a parent cuboid sharing an edge with the current child cuboid, a parent cuboid sharing a face with the current child cuboid, a parent cuboid adjacent to the current parent cuboid, a parent cuboid sharing a vertex with the current parent cuboid, a parent cuboid sharing an edge with the current parent cuboid, a parent cuboid sharing a face with the current parent cuboid, etc. As shown in FIG. 4, current child cuboid 400 may belong to a current parent cuboid 402. Following the scanning order of the occupancy words and occupancy bits of nodes of the occupancy tree, the occupancy bits of four child cuboids 404, 406, 408, and 410, belonging to the same current parent cuboid 402, may have already been coded. The occupancy bit of child cuboids 412 of preceding parent cuboids may have already been coded. The occupancy bits of parent cuboids 414, for which the occupancy bits of child cuboids have not already been coded, may have already been coded. The already-coded occupancy bits of cuboids 404, 406, 408, 410, 412, and 414 may be used to code the occupancy bit of the current child cuboid 400.

The number (e.g., quantity) of possible occupancy configurations (e.g., sets of one or more occupancy words and/or occupancy bits) for a neighborhood of a current child cuboid may be 2^{N}, where N is the number (e.g., quantity) of cuboids in the neighborhood of the current child cuboid with already-coded occupancy bits. The neighborhood of the current child cuboid may comprise several dozens of cuboids. The neighborhood of the current child cuboid (e.g., several dozens of cuboids) may comprise 26 adjacent parent cuboids sharing a face, an, edge, and/or a vertex with the parent cuboid of the current child cuboid and also several adjacent child cuboids having occupancy bits already coded sharing a face, an edge, or a vertex with the current child cuboid. The occupancy configuration for a neighborhood of the current child cuboid may have billions of possible occupancy configurations, even limited to a subset of the adjacent cuboids, making its direct use impractical. An encoder and/or decoder may use the occupancy configuration for a neighborhood of the current child cuboid to select the context (e.g., a probability model), among a set of contexts, of a binary entropy coder (e.g., binary arithmetic coder) that may code the occupancy bit of the current child cuboid. The context-based binary entropy coding may be similar to the Context Adaptive Binary Arithmetic Coder (CABAC) used in MPEG-H Part 2 (also known as High Efficiency Video Coding (HEVC)).

An encoder and/or a decoder may use several methods to reduce the occupancy configurations for a neighborhood of a current child cuboid being coded to a practical number (e.g., quantity) of reduced occupancy configurations. The 26 or 64 occupancy configurations of the six adjacent parent cuboids sharing a face with the parent cuboid of the current child cuboid may be reduced to 9 occupancy configurations. The occupancy configurations may be reduced by using geometry invariance. An occupancy score for the current child cuboid may be obtained from the 226 occupancy configurations of the 26 adjacent parent cuboids. The score may be further reduced into a ternary occupancy prediction (e.g., “predicted occupied,” “unsure”, or “predicted unoccupied”) by using score thresholds. The number (e.g., quantity) of occupied adjacent child cuboids and the number (e.g., quantity) of unoccupied adjacent child cuboids may be used instead of the individual occupancies of these child cuboids.

An encoder and/or a decoder using/employing one or more of the methods described herein may reduce the number (e.g., quantity) of possible occupancy configurations for a neighborhood of a current child cuboid to a more manageable number (e.g., a few thousands). It has been observed that instead of associating a reduced number (e.g., quantity) of contexts (e.g., probability models) directly to the reduced occupancy configurations, another mechanism may be used, namely Optimal Binary Coders with Update on the Fly (OBUF). An encoder and/or a decoder may implement OBUF to limit the number (e.g., quantity) of contexts to a lower number (e.g., 32 contexts).

OBUF may use a limited number (e.g., 32) of contexts (e.g., probability models). The number (e.g., quantity) of contexts in OBUF may be a fixed number (e.g., fixed quantity). The contexts used by OBUF may be ordered, referred to by a context index (e.g., a context index in the range of 0 to 31), and associated from a lowest virtual probability to a highest virtual probability to code a “1”. A Look-Up Table (LUT) of context indices may be initialized at the beginning of a point cloud coding process. For example, the LUT may initially point to a context (e.g., with a context index 15) with the median virtual probability to code a “1” for all input. The LUT may initially point to a context with the median virtual probability to code a “1”, among the limited number (e.g., quantity) of contexts, for all input. This LUT may take an occupancy configuration for a neighborhood of current child cuboid as input and output the context index associated with the occupancy configuration. The LUT may have as many entries as reduced occupancy configurations (e.g., around a few thousand entries). The coding of the occupancy bit of a current child cuboid may comprise steps including determining the reduced occupancy configuration of the current child node, obtaining a context index by using the reduced occupancy configuration as an entry to the LUT, coding the occupancy bit of the current child cuboid by using the context pointed to (or indicated) by the context index, and updating the LUT entry corresponding to the reduced occupancy configuration, for example, based on the value of the coded occupancy bit of the current child cuboid. The LUT entry may be decreased to a lower context index value, for example, if a binary “0” (e.g., indicating the current child cuboid is unoccupied) is coded. The LUT entry may be increased to a higher context index value, for example, if a binary “1” (e.g., indicating the current child cuboid is occupied) is coded. The update process of the context index may be, for example, based on a theoretical model of optimal distribution for virtual probabilities associated with the limited number (e.g., quantity) of contexts. This virtual probability may be fixed by a model and may be different from the internal probability of the context that may evolve, for example, if the coding of bits of data occurs. The evolution of the internal context may follow a well-known process similar to the process in CABAC.

An encoder and/or a decoder may implement a “dynamic OBUF” scheme. The “dynamic OBUF” scheme may enable an encoder and/or a decoder to handle a much larger number (e.g., quantity) of occupancy configurations for a neighborhood of a current child cuboid, for example, than general OBUF. The use of a larger number (e.g., quantity) of occupancy configurations for a neighborhood of a current child cuboid may lead to improved compression capabilities, and may maintain complexity within reasonable bounds. By using an occupancy tree compressed by OBUF, an encoder and/or a decoder may reach a lossless compression performance as good as 1 bit per point (bpp) for coding the geometry of dense point clouds. An encoder and/or a decoder may implement dynamic OBUF to potentially further reduce the bit rate by more than 25% to 0.7 bpp.

OBUF may not take as input a large variety of reduced occupancy configurations for a neighborhood of a current child cuboid, and may potentially cause a loss of useful correlation. With OBUF, the size of the LUT of context indices may be increased to handle more various occupancy configurations for a neighborhood of a current child cuboid as input. Due to such increase, statistics may be diluted, and compression performance may be worsened. For example, if the LUT has millions of entries and the point cloud has a hundred thousand points, then most of the entries may be never visited (e.g., looked up, accessed, etc.). Many entries may be visited only a few times and their associated context index may not be updated enough times to reflect any meaningful correlation between the occupancy configuration value and the probability of occupancy of the current child cuboid. Dynamic OBUF may be implemented to mitigate the dilution of statistics due to the increase of the number (e.g., quantity) of occupancy configurations for a neighborhood of a current child cuboid. This mitigation may be performed by a “dynamic reduction” of occupancy configurations in dynamic OBUF.

Dynamic OBUF may add an extra step of reduction of occupancy configurations for a neighborhood of a current child cuboid, for example, before using the LUT of context indices. This step may be called a dynamic reduction because it evolves, for example, based on the progress of the coding of the point cloud or, more precisely, based on already visited (e.g., looked up in the LUT) occupancy configurations.

As discussed herein, many possible occupancy configurations for a neighborhood of a current child cuboid may be potentially involved but only a subset may be visited if the coding of a point cloud occurs. This subset may characterize the type of the point cloud. For example, most of the visited occupancy configurations may exhibit occupied adjacent cuboids of a current child cuboid, for example, if AR or VR dense point clouds are being coded. On the other hand, most of the visited occupancy configurations may exhibit only a few occupied adjacent cuboids of a current child cuboid, for example, if sensor-acquired sparse point clouds are being coded. The role of the dynamic reduction may be to obtain a more precise correlation, for example, based on the most visited occupancy configuration while putting aside (e.g., reducing aggressively) other occupancy configurations that are much less visited. The dynamic reduction may be updated on-the-fly. The dynamic reduction may be updated on-the-fly, for example, after each visit (e.g., a lookup in the LUT) of an occupancy configuration, for example, if the coding of occupancy data occurs.

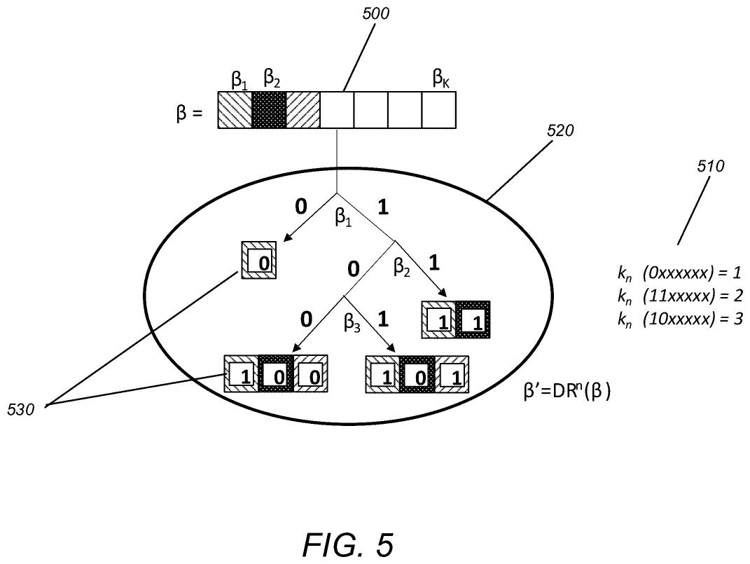

FIG. 5 shows an example of a dynamic reduction function DR that may be used in dynamic OBUF. The dynamic reduction function DR may be obtained by masking bits βⱼ of occupancy configurations 500

$$β = {β}_{1} … {β}_{K}$$

made of K bits. The size of the mask may decrease, for example, if occupancy configurations are visited (e.g., looked up in the LUT) a certain number (e.g., quantity) of times. The initial dynamic reduction function DR⁰ may mask all bits for all occupancy configurations such that it is a constant function DR⁰(β)=0 for all occupancy configurations β. The dynamic reduction function may evolve from a function DRⁿ to an updated function DRⁿ⁺¹. The dynamic reduction function may evolve from a function DRⁿ to an updated function DRⁿ⁺¹, for example, after each coding of an occupancy bit. The function may be defined by

$${β}^{′} = {DR}^{n} ( β ) = {β}_{1} … {β}_{k n ( β )}$$

where kₙ(β) 510 is the number (e.g., quantity) of non-masked bits. The initialization of DR⁰ may correspond to k₀(β)=0, and the natural evolution of the reduction function toward finer statistics may lead to an increasing number (e.g., quantity) of non-masked bits kₙ(β)≤kₙ₊₁(β). The dynamic reduction function may be entirely determined by the values of kₙ for all occupancy configurations β.

The visits (e.g., instances of a lookup in the LUT) to occupancy configurations may be tracked by a variable NV(β′) for all dynamically reduced occupancy configurations β′=DRⁿ(β). The corresponding number (e.g., quantity) of visits NV(β^{V}′) may be increased by one, for example, after each instance of coding of an occupancy bit based on an occupancy configuration β^{V}. If this number (e.g., quantity) of visits NV(β^{V}′) is greater than a threshold th_{V},

$$NV ( {β}^{V ′} ) > {th}_{V}$$

then the number (e.g., quantity) of unmasked bits kₙ(β) may be increased by one for all occupancy configurations β being dynamically reduced to β^{V}′. This corresponds to replacing the dynamically reduced occupancy configuration β^{V}′ by the two new dynamically reduced occupancy configurations β⁰′ and β¹′ defined by

$${β}^{0 ′} = {β}^{V ′} 0 = {β}_{1}^{V} … {β}_{kn ( β )}^{V} 0 and {β}^{1 ′} = {β}^{V ′} 1 = {β}_{1}^{V} … {β}_{kn ( β )}^{V} 1.$$

In other words, the number (e.g., quantity) of unmasked bits has been increased by one kₙ₊₁(β)=kₙ(β)+1 for all occupancy configurations β such that DRⁿ(β)=β^{V}′. The number (e.g., quantity) of visits of the two new dynamically reduced occupancy configurations may be initialized to zero

$$NV ( {β}^{0 ′} ) = NV ( {β}^{1 ′} ) = 0. \qquad ( I )$$

At the start of the coding, the initial number (e.g., quantity) of visits for the initial dynamic reduction function DR⁰ may be set to

$$NV ( {DR}^{0} ( β ) ) = NV ( 0 ) = 0 ,$$

and the evolution of NV on dynamically reduced occupancy configurations may be entirely defined.

The corresponding LUT entry LUT[β^{V}′] may be replaced by the two new entries LUT[β⁰′] and LUT[β¹′] that are initialized by the coder index associated with β^{V}′. The corresponding LUT entry LUT[β^{V}′] may be replaced by the two new entries LUT[β⁰′] and LUT[β¹′] that are initialized by the coder index associated with β^{V}′, for example, if a dynamically reduced occupancy configuration β^{V}′ is replaced by the two new dynamically reduced occupancy configurations β⁰′ and β¹′,

$$LUT [ {β}^{0 ′} ] = LUT [ {β}^{1 ′} ] = LUT [ {β}^{V ′} ] , \qquad ( II )$$

and then evolve separately. The evolution of the LUT of coder indices on dynamically reduced occupancy configurations may be entirely defined.

The reduction function DRⁿ may be modeled by a series of growing binary trees Tⁿ 520 whose leaf nodes 530 are the reduced occupancy configurations β′=DRⁿ(β). The initial tree may be the single root node associated with 0=DR⁰(β). The replacement of the dynamically reduced to β^{V}′ by β⁰′ and β¹′ may correspond to growing the tree Tⁿ from the leaf node associated with β^{V}′, for example, by attaching to it two new nodes associated with β⁰′ and β¹′. The tree Tⁿ⁺¹ may be obtained by this growth. The number (e.g., quantity) of visits NV and the LUT of context indices may be defined on the leaf nodes and evolve with the growth of the tree through equations (I) and (II).

The practical implementation of dynamic OBUF may be made by the storage of the array NV[β′] and the LUT[β′] of context indices, as well as the trees Tⁿ 520. An alternative to the storage of the trees may be to store the array kₙ[β] 510 of the number (e.g., quantity) of non-masked bits.

A limitation for implementing dynamic OBUF may be its memory footprint. In some applications, a few million occupancy configurations may be practically handled, leading to about 20 bits βᵢ constituting an entry configuration β to the reduction function DR. Each bit βᵢ may correspond to the occupancy status of a neighboring cuboid of a current child cuboid or a set of neighboring cuboids of a current child cuboid.

Higher (e.g., more significant) bits βᵢ (e.g., β₀, β₁, etc.) may be the first bits to be unmasked. Higher (e.g., more significant) bits βᵢ (e.g., β₀, β₁, etc.) may be the first bits to be unmasked, for example, during the evolution of the dynamic reduction function DR. The order of neighbor-based information put in the bits βᵢ may impact the compression performance. Neighboring information may be ordered from higher (e.g., highest) priority to lower priority and put in this order into the bits βᵢ, from higher to lower weight. The priority may be, from the most important to the least important, occupancy of sets of adjacent neighboring child cuboids, then occupancy of adjacent neighboring child cuboids, then occupancy of adjacent neighboring parent cuboids, then occupancy of non-adjacent neighboring child nodes, and finally occupancy of non-adjacent neighboring parent nodes. Adjacent nodes sharing a face with the current child node may also have higher priority than adjacent nodes sharing an edge (but not sharing a face) with the current child node. Adjacent nodes sharing an edge with the current child node may have higher priority than adjacent nodes sharing only a vertex with the current child node.

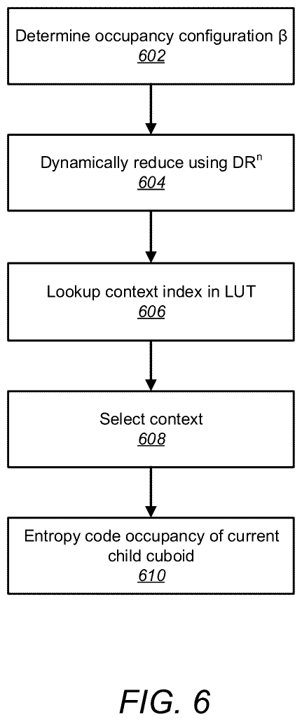

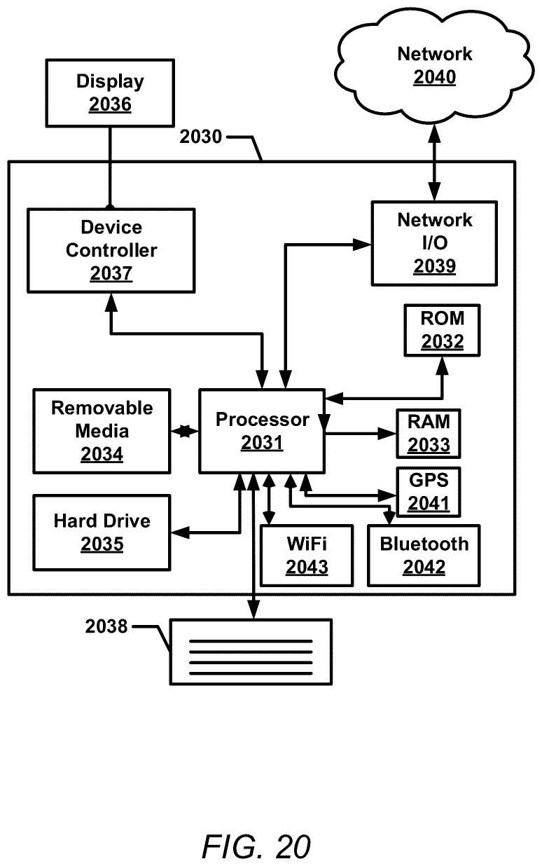

FIG. 6 shows an example method for coding occupancy of a cuboid using dynamic OBUF. More specifically, FIG. 6 shows an example method for coding occupancy bit of a current child cuboid using dynamic OBUF. One or more steps of FIG. 6 may be performed by an encoder and/or a decoder (e.g., the encoder 114 and/or decoder 120 in FIG. 1). All or portions of the flowchart may be implemented by a coder (e.g., the encoder 114 and/or decoder 120 in FIG. 1), an example computer system 2000 in FIG. 20, and/or an example computing device 2130 in FIG. 21.

At step 602, an occupancy configuration (e.g., occupancy configuration β) of the current child cuboid may be determined. The occupancy configuration (e.g., occupancy configuration β) of the current child cuboid may be determined, for example, based on occupancy bits of already-coded cuboids in a neighborhood of the current child cuboid. At step 604, the occupancy configuration (e.g., occupancy configuration β) may be dynamically reduced. The occupancy configuration may be dynamically reduced, for example, using a dynamic reduction function DRⁿ. For example, the occupancy configuration β may be dynamically reduced into a reduced occupancy configuration β′=DRⁿ(β). At step 606, context index may be looked up, for example, in a look-up table (LUT). For example, the encoder and/or decoder may look up context index LUT[β′] in the LUT of the dynamic OBUF. At step 608, context (e.g., probability model) may be selected. For example, the context (e.g., probability model) pointed to by the context index may be selected. At step 610, occupancy of the current child cuboid may be entropy coded. For example, the occupancy bit of the current child cuboid may be entropy coded (e.g., arithmetic coded), for example, based on the context. The occupancy bit of the current child cuboid may be coded based on the occupancy bits of the already-coded cuboids neighboring the current child cuboid.

Although not shown in FIG. 6, the encoder and/or decoder may update the reduction function and/or update the context index. For example, the encoder and/or decoder may update the reduction function DRⁿ into DRⁿ⁺¹ and/or update the context index LUT[β′], for example, based on the occupancy bit of the current child cuboid. The method of FIG. 6 may be repeated for additional or all child cuboids of parent cuboids corresponding to nodes of the occupancy tree in a scan order, such as the scan order discussed herein with respect to FIG. 3.

In general, the occupancy tree is a lossless compression technique. The occupancy tree may be adapted to provide lossy compression, for example, by modifying the point cloud on the encoder side (e.g., down-sampling, removing points, moving points, etc.). The performance of the lossy compression may be weak. The lossy compression may be a useful lossless compression technique for dense point clouds.

One approach to lossy compression for point cloud geometry may be to set the maximum depth of the occupancy tree to not reach the smallest volume size of one voxel but instead to stop at a bigger volume size (e.g., N×N×N cuboids (e.g., cubes), where N>1). The geometry of the points belonging to each occupied leaf node associated with the bigger volumes may then be modeled. This approach may be particularly suited for dense and smooth point clouds that may be locally modeled by smooth functions such as planes or polynomials. The coding cost may become the cost of the occupancy tree plus the cost of the local model in each of the occupied leaf nodes.

A scheme for modeling the geometry of the points belonging to each occupied leaf node associated with a volume size larger than one voxel may use sets of triangles as local models. The scheme may be referred to as the “TriSoup” scheme. TriSoup is short for “Triangle Soup” because the connectivity between triangles may not be part of the models. An occupied leaf node of an occupancy tree that corresponds to a cuboid with a volume greater than one voxel may be referred to as a TriSoup node. An edge belonging to at least one cuboid corresponding to a TriSoup node may be referred to as a TriSoup edge. A TriSoup node may comprise a presence flag (sₖ) for each TriSoup edge of its corresponding occupied cuboid. A presence flag (sₖ) of a TriSoup edge may indicate whether a TriSoup vertex (Vₖ) is present or not on the TriSoup edge. At most one TriSoup vertex (Vₖ) may be present on a TriSoup edge. For each vertex (Vₖ) present on a TriSoup edge of an occupied cuboid, the TriSoup node corresponding to the occupied cuboid may comprise a position (pₖ) of the vertex (Vₖ) along the TriSoup edge.

In addition to the occupancy words of an occupancy tree, an encoder may entropy encode, for each TriSoup node of the occupancy tree, the TriSoup vertex presence flags and positions of each TriSoup edge belonging to TriSoup nodes of the occupancy trec. A decoder may similarly entropy decode the TriSoup vertex presence flags and positions of each TriSoup edge and vertex along a respective TriSoup edge belonging to a TriSoup node of the occupancy tree, in addition to the occupancy words of the occupancy tree.

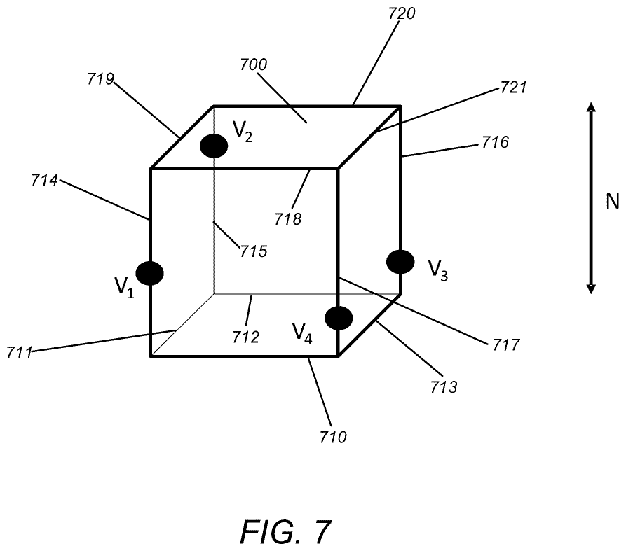

FIG. 7 shows an example of an occupied cuboid (e.g., cube) 700. More specifically, FIG. 7 shows an example of an occupied cuboid (e.g., cube) 700 of size N×N×N (where N>1) that corresponds to a TriSoup node of an occupancy tree. An occupied cuboid 700 may comprise edges (e.g., TriSoup edges 710-721). The TriSoup node, corresponding to the occupied cuboid 700, may comprise a presence flag (sₖ) for each edge (e.g., each TriSoup edge of the TriSoup edges 710-721). For example, the presence flag of a TriSoup edge 714 may indicate that a TriSoup vertex V₁ is present on the TriSoup edge 714. The presence flag of a TriSoup edge 715 may indicate that a TriSoup vertex V₂ is present on the TriSoup edge 715. The presence flag of a TriSoup edge 716 may indicate that a TriSoup vertex V₃ is present on the TriSoup edge 716. The presence flag of a TriSoup edge 717 may indicate that a TriSoup vertex V₄ is present on the TriSoup edge 717. The presence flags of the remaining TriSoup edges each may indicate that a TriSoup vertex is not present on their corresponding TriSoup edge. The TriSoup node, corresponding to the occupied cuboid 700, may comprise a position for each TriSoup vertex present along one of its TriSoup edges 710-721. More specifically, the TriSoup node, corresponding to the occupied cuboid 700, may comprise a position p₁ for TriSoup vertex V₁, a position p₂ for TriSoup vertex V₂, a position p₃ for TriSoup vertex V₃, and a position p₄ for TriSoup vertex V₄. The TriSoup vertices may be shared among TriSoup nodes along common TriSoup edge(s).

A presence flag (sₖ) and, if the presence flag (sₖ) may indicate the presence of a vertex, a position (pₖ) of a current TriSoup edge may be entropy coded. The presence flag (sₖ) and position (pₖ) may be individually or collectively referred to as vertex information or TriSoup vertex information. A presence flag (sₖ) and, if the presence flag (sₖ) indicates the presence of a vertex, a position (pₖ) of a current TriSoup edge may be entropy coded, for example, based on already-coded presence flags and positions, of present TriSoup vertices, of TriSoup edges that neighbor the current TriSoup edge. A presence flag (sₖ) and, if the presence flag (sₖ) may indicate the presence of a vertex, a position (pₖ) of a current TriSoup edge (e.g., indicating a position of the vertex the edge is along) may be additionally or alternatively entropy coded. The presence flag (sₖ) and the position (pₖ) of a current TriSoup edge may be additionally or alternatively entropy coded, for example, based on occupancies of cuboids that neighbor the current TriSoup edge. Similar to the entropy coding of the occupancy bits of the occupancy tree, a configuration β_{TS} for a neighborhood (also referred to as a neighborhood configuration β_{TS}) of a current TriSoup edge may be obtained and dynamically reduced into a reduced configuration β_{TS}′=DRⁿ(β_{TS}), for example, by using a dynamic OBUF scheme for TriSoup. A context index LUT[β_{TS}′] may be obtained from the OBUF LUT. At least a part of the vertex information of the current TriSoup edge may be entropy coded using the context (e.g., probability model) pointed to by the context index.

The TriSoup vertex position (pₖ) (if present) along its TriSoup edge may be binarized. The TriSoup vertex position (pₖ) (if present) along its TriSoup edge may be binarized, for example, to use a binary entropy coder to entropy code at least part of the vertex information of the current TriSoup edge. A number (e.g., quantity) of bits No may be set for the quantization of the TriSoup vertex position (pₖ) along the TriSoup edge of length N. The TriSoup edge of length N may be uniformly divided into 2^{Nb} quantization intervals. By doing so, the TriSoup vertex position (pₖ) may be represented by No bits (pₖ^{j}, j=1, . . . , N_{b}) that may be individually coded by the dynamic OBUF scheme as well as the bit corresponding to the presence flag (sₖ). The neighborhood configuration β_{TS}. the OBUF reduction function DRⁿ, and the context index may depend on the nature, characteristic, and/or property of the coded bit (e.g., a presence flag (sₖ), a highest position bit (pₖ₁), a second highest position bit (pₖ₂), etc.) of the coded bit (e.g., presence flag (sₖ), highest position bit (pₖ¹), second highest position bit (pₖ²), etc.). There may practically be several dynamic OBUF schemes, each dedicated to a specific bit of information (e.g., presence flag (sₖ) or position bit (pₖ^{j})) of the vertex information.

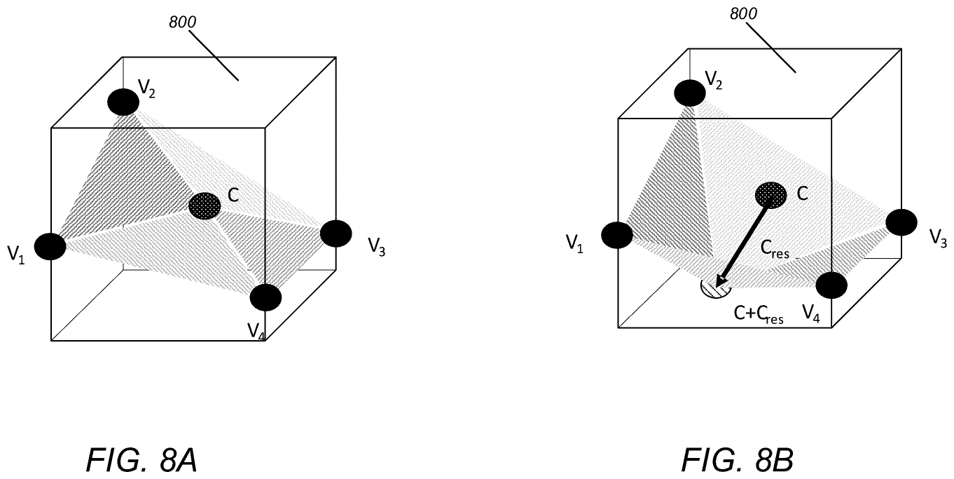

FIG. 8(a) shows an example cuboid (e.g., cube) 800 corresponding to a TriSoup node. A cuboid 800 may correspond to a TriSoup node with a number K of TriSoup vertices Vₖ. Within cuboid 800, TriSoup triangles may be constructed from the TriSoup vertices Vₖ. TriSoup triangles may be constructed from the TriSoup vertices Vₖ, for example, if at least three (K≥3) TriSoup vertices are present on the TriSoup edges of cuboid 800. For example, with respect to FIG. 8(a), four TriSoup vertices may be present and TriSoup triangles may be constructed. The TriSoup triangles may be constructed around the centroid vertex C defined as the mean of the TriSoup vertices Vₖ. A dominant direction may be determined, then vertices Vₖ may be ordered by turning around this direction, and the following K TriSoup triangles may be constructed: V₁V₂C, V₂V₃C, . . . , V_{K}V₁C. The dominant direction may be chosen among the three directions respectively parallel to the axes of the 3D space to increase or maximize the 2D surface of the triangles, for example, if the triangles are projected along the dominant direction. By doing so, the dominant direction may be somewhat perpendicular to a local surface defined by the points of the point cloud belonging to the TriSoup node.

FIG. 8(b) shows an example refinement to the TriSoup model. The TriSoup model may be refined by coding a centroid residual value. A centroid residual value Cᵣₑₛ may be coded into the bitstream. A centroid residual value Cᵣₑₛ may be coded into the bitstream, for example, to use C+Cᵣₑₛ instead of C as a pivoting vertex for the triangles. By using C+Cᵣₑₛ as the pivoting vertex for the triangles, the vertex C+Cᵣₑₛ may be closer to the points of the point cloud than the centroid C, the reconstruction error may be lowered, leading to lower distortion at the cost of a small increase in bitrate needed for coding Cᵣₑₛ.

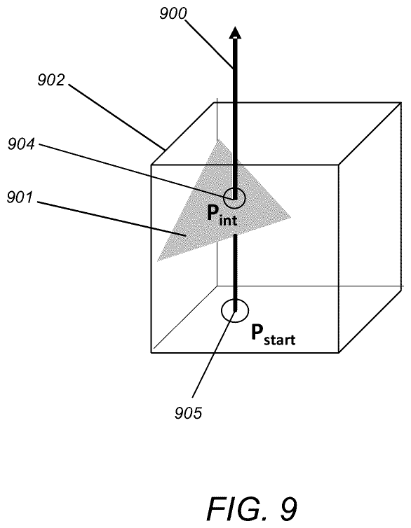

FIG. 9 shows an example of voxelization. Voxelization may refer to reconstruction of a decoded point cloud from a set of TriSoup triangles. Voxelization may be performed by ray tracing for each triangle individually. Voxelization may be performed by ray tracing for each triangle individually, for example, before removing duplicated points between voxelized triangles. As shown in FIG. 9, rays 900 may be launched parallel to one of the three axes of the 3D space. Rays 900 may be launched starting from integer coordinates Pₛₜₐᵣₜ 905 (e.g., an origin point). The intersection Pᵢₙₜ 904, if any, of the rays 900 with a TriSoup triangle 901 belonging to a cuboid (e.g., cube) 902 corresponding to a TriSoup node may be rounded to obtain a decoded point. This intersection Pᵢₙₜ may be found, for example, using the Möller-Trumbore algorithm.

TriSoup vertices of TriSoup nodes may need to be quantized to certain, acceptable vertex positions to ensure continuity of a triangle-based modeling between TriSoup nodes. As a result, Tri-Soup modeling that approximates occupied voxels within a TriSoup node may not match occupied voxels determined to be within a TriSoup triangle with quantized TriSoup vertices. Some voxels may be missed, for example, if voxelizing of the TriSoup triangle occurs. Techniques including the “halo” method and “fine-ray-launch” method, as described herein, have been introduced to enhance the voxelization process in an effort to improve voxel reconnection between triangles.

Both the halo and fine-ray-launch methods attempt to increase possible intersections between launched rays and triangles to “recapture” missed voxels resulting from quantizing vertices of TriSoup triangles. While the halo method does not significantly increase complexity and processing costs, the fine-ray-launch method may significantly increase processing costs because a plurality of rays at non-integer coordinates (referred to as fine rays) are launched additionally for each ray at integer coordinates to increase possible intersections between rays and TriSoup triangles. Not only does processing costs significantly increase to implement fine-ray-launch methods, but the fine-ray-launch method also overlaps with the halo method and may recapture some of the same missed voxels, which may reduce its effectiveness. Examples of the present disclosure include enhancing a voxelization process by adding one or more additional points close to each determined point (e.g., intersection point) of a TriSoup triangle and quantizing, or voxelizing, the one or more additional points along with the determined point of the TriSoup triangle. The one or more additional points may be extended from the determined point, for example, in a direction not aligned with a plane of the TriSoup triangle. This quantization process is less computationally intensive than fine-ray-launch methods, and quantization of these one or more additional points may recapture voxels that may not be identified by halo methods and, as a result, may be implemented with halo methods to enhance voxelization.

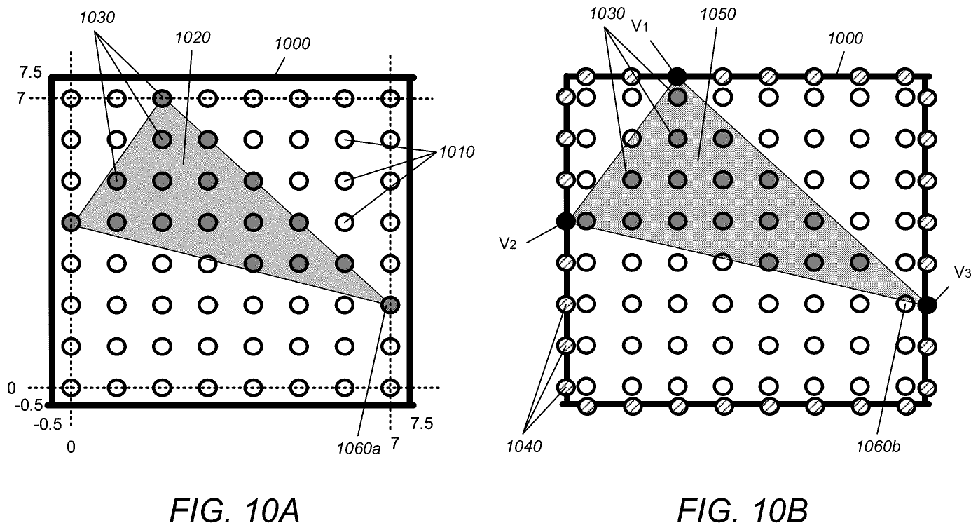

FIG. 10A shows an example of approximating a TriSoup triangle of occupied voxels. More specifically, FIG. 10A shows an example of a TriSoup method approximating a triangle (e.g., triangle 1020) of occupied voxels (e.g., occupied voxels 1030) in a cuboid corresponding to a TriSoup node. For case of illustration, the boundary 1000 of the cuboid associated with the TriSoup node, as shown in FIG. 10A, is depicted in two dimensions (2D), rather than three dimensions (3D), and shows a size of 8×8. The cuboid, and associated TriSoup node, may have a size of 8×8×8 (represented as 8×8 as shown in FIG. 10(a)) and may encompass points or voxels (e.g., voxels 1010) whose integral coordinates are between 0 and 7. By construction of TriSoup nodes, the boundary 1000 of TriSoup nodes may be located between voxels (e.g., at coordinates −0.5 and 7.5). The TriSoup method may approximate occupied voxels 1030 of the point cloud, for example, by at least one triangle 1020.

FIG. 10B shows an example of approximating a TriSoup triangle of occupied voxels. More specifically, FIG. 10B shows an example of a TriSoup method approximating a triangle (e.g., triangle 1050) determined for the cuboid shown in FIG. 10A. To ensure continuity of a triangle-based modeling between TriSoup nodes, the approximated triangle 1020 shown in FIG. 10A may be modeled by a TriSoup triangle 1050 with at least one vertex V₁, V₂, and/or V₃ belonging to a node boundary 1000 of the cuboid. Vertices, Vᵢ, of the TriSoup triangle 1050 on the node boundary 1000 may be quantized to certain acceptable vertex positions 1040 (e.g., belonging to a discrete set of dequantized positions) along edges of the cuboid, for example, depending on a quantization function. Modeling the TriSoup triangle 1050 may lead to some missed voxels. For example, modeling the TriSoup triangle 1050 may lead to missed voxels, such as voxel 1060b that was present and shown as voxel 1060a in FIG. 10A. A missed voxel (e.g., voxel 1060b) may not be recovered by an intersection of a ray with the TriSoup triangle 1050 but may still correspond to a point of the original point cloud.

The halo method has been introduced, for example, to capture part of these mixed voxels. The halo method may be based on the Möller-Trumbore algorithm that may be used to voxelize a TriSoup triangle by ray tracing, as described herein.

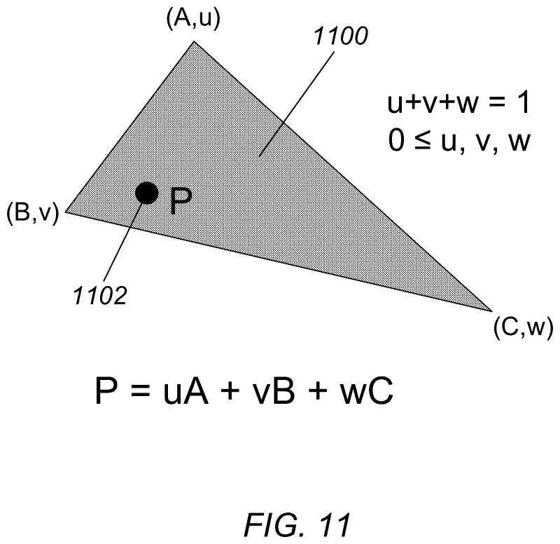

FIG. 11 shows an example of barycentric coordinates of a point relative to a TriSoup triangle. More specifically, FIG. 11 shows an example of barycentric coordinates (u, v, w) of a point 1102 (e.g., P) relative to a TriSoup triangle 1100 that is used by the Möller-Trumbore algorithm to determine if a ray intersects the TriSoup triangle 1100. The vertices of the example TriSoup triangle 1100 shown in FIG. 11 are labeled A, B, and C. The Möller-Trumbore algorithm may determine an intersection between the ray and a plane defined by (or passing through) the vertices A, B, and C. The intersection between the ray and the plane may be determined as point 1102 and may be uniquely represented, for example, as a sum of the three vertices:

$$P = uA + vB + wC$$

with the condition that u+v+w=1. The convex hull (i.e., TriSoup triangle 1100) of the three vertices A, B, and C may be equal to the set of all points P such that the barycentric coordinates u, v, and w may each be greater than or equal to zero:

$$0 \leq u , v , w$$

Each of the barycentric coordinates u, v, and w determined by the Möller-Trumbore algorithm may be compared to 0, for example, to determine if a ray intersects the TriSoup triangle 1100. It may be determined that the ray does not intersect the TriSoup triangle 1100, for example, if at least one of barycentric coordinates is less than 0.

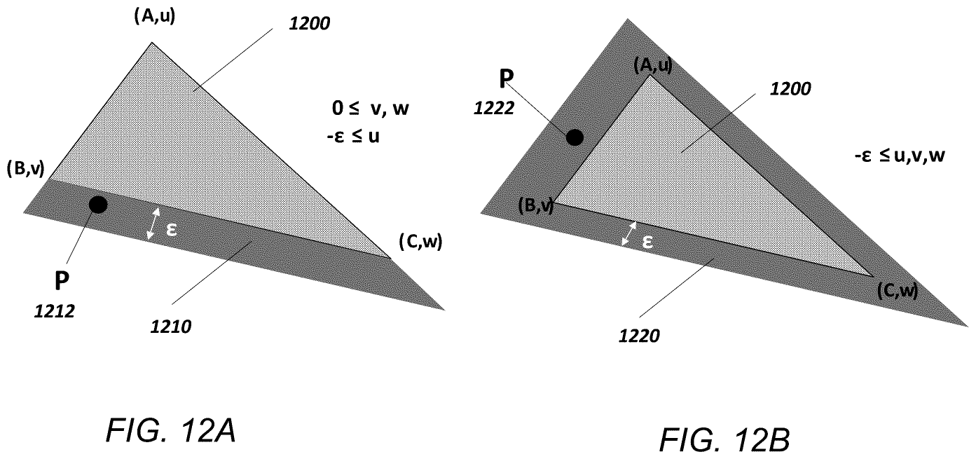

FIGS. 12A and 12B show examples of a halo method. More specifically, FIGS. 12A and 12B show examples of a halo method where one or more inequalities of barycentric coordinates u, v, and w are relaxed to permit points within a “halo” of a TriSoup triangle (e.g., triangle 1200) to be identified. As shown in FIG. 12A, relaxing the inequality 0≤u into a less constraining inequality −ε≤u for a fixed positive parameter ε may add a halo 1210 along the edge BC of the TriSoup triangle 1200. The relaxing of the inequality may permit one or more points (e.g., point 1212) within halo 1210 but outside of the TriSoup triangle 1200 to be determined and/or identified. As shown in FIG. 12B, relaxing all three inequalities 0≤u, v, w into less constraining inequalities −ε≤u, v, w may lead to a halo 1220 that surrounds the perimeter of TriSoup triangle 1200. The relaxing of all three inequalities may permit points (e.g., point 1222) to be determined and/or identified.

In the Möller-Trumbore algorithm, an intersection point of a ray with a plane comprising a TriSoup triangle may be determined based on computing the values of u, v, and w. The intersection point may be determined to be in the TriSoup triangle (e.g., within or on an edge of the TriSoup triangle), for example, based on verifying that each of the barycentric coordinates u, v, and w are greater than or equal to 0 (e.g., 0≤u, v, w). The intersection point may, otherwise, be determined to be outside of the TriSoup triangle. The halo method may replace an inequality in the verification by −ε≤u, v, w such that the intersection point may be confirmed to be in (or belong to) the TriSoup triangle that is extended by its halo. The halo method therefore does not increase complexity and/or does not significantly increase processing needs.

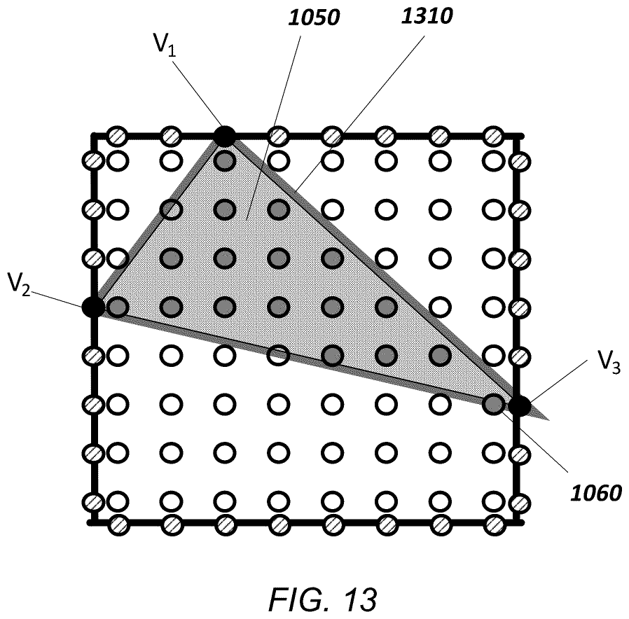

FIG. 13 shows an example of a halo method used for a TriSoup triangle. More specifically, FIG. 13 shows an example of the halo method used for a TriSoup triangle 1050 (e.g., TriSoup triangle 1050 as described herein with respect to FIG. 10B). By adding a halo 1310 to the TriSoup triangle 1050, voxel 1060 (e.g., which corresponds to the missed voxel 1060B described herein with respect to FIG. 10B) may be captured by the halo. By adding a halo, a better voxel continuity between TriSoup triangles may be obtained through the boundaries of TriSoup nodes, which may reduce holes (i.e., missing voxels). Additionally, quantitative geometry metrics representative of the amount of error between an original point cloud and a modeled and/or decoded point cloud may be reduced by adding the halo.

A voxelization process may use ray-triangle intersection algorithms (e.g., the Möller-Trumbore algorithm), that rely on launching rays, for example, to determine whether rays intersect with TriSoup triangles. The ray-triangle intersection algorithms may also be used to determine, at which points of the TriSoup triangles that the rays intersect with TriSoup triangles. Rays may be launched from integral coordinates that may correspond to centers of voxels. A ray, launched parallel to a coordinate axis in 3D space, may intersect a TriSoup triangle, for example, if and only if the projection, along the ray direction, of the center of a voxel belongs to the TriSoup triangle. That is, it may be determined that a ray intersects a TriSoup triangle, for example, if the point of intersection corresponds to the center of the voxel. Launched rays, however, may miss voxels that significantly intersect a TriSoup triangle in 3D space, if the centers of the voxels do not intersect the TriSoup triangles. The fine-ray-launch method may be implemented with the halo method to further improve voxelization of TriSoup triangles using ray-triangle intersections.

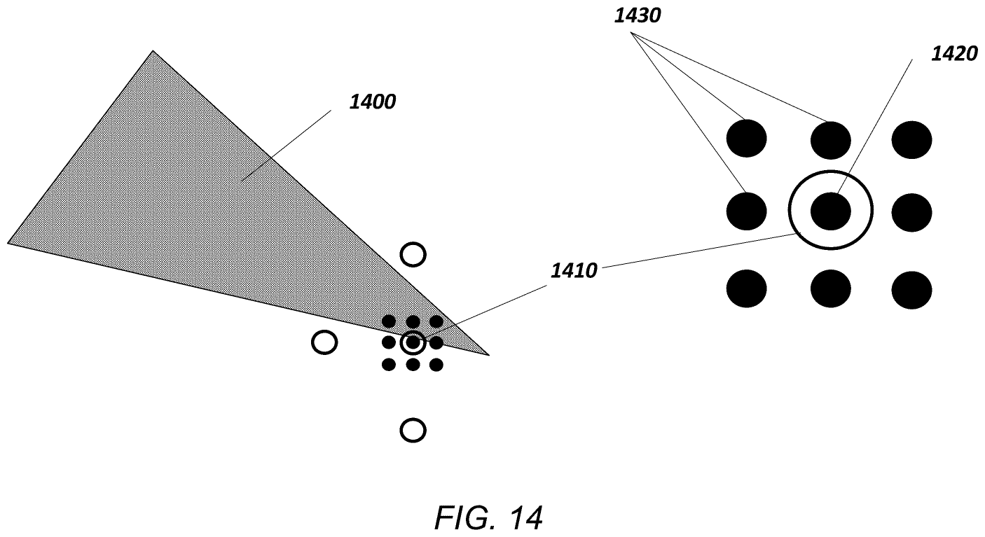

FIG. 14 shows an example of a fine-ray launch method. More specifically, FIG. 14 shows an example of a fine-ray-launch method for refining ray launch methods. Additional rays may be launched, for example, around each ray launched from integral coordinates. A first ray may be launched, along the ray direction, from integral coordinates 1420 corresponding to the center of voxels 1410. The first ray may miss intersecting a TriSoup triangle 1400. Additional rays may be launched from coordinates 1430, for example, from around integral coordinates 1420 of the first ray. A plurality of additional rays (e.g., 8 fine rays) at non-integral coordinates (e.g., coordinates 1430) around each ray may be launched, for example, for each ray launched from an integral coordinate (e.g., integral coordinate 1420). Accordingly, an intersection with the TriSoup triangle 1400 may be obtained in case a voxel, whose center is located on the first ray, intersects TriSoup triangle 1400 significantly. Eight additional rays may be launched, for example, from coordinates 1430 located at ±⅛ of integral coordinate spacing relative to the integral coordinates 1420 of the first ray. The voxel may be determined to “significantly” intersect the TriSoup triangle 1400, for example, based on an intersection between the voxel and TriSoup triangle 1400 being within a threshold amount (e.g., +⅛) of the center of the voxel.

Because at most three inequality tests relative to 0 may be changed to inequality tests relative to −ε in the Möller-Trumbore algorithm, the halo method, as described herein, does not add significant complexity to voxelization. The complexity of Möller-Trumbore algorithm plus the halo method may not increase over using the Möller-Trumbore algorithm alone, for example, for voxelizing. By contrast, the fine-ray-launch method increases the number of launched rays and is computationally costly. The benefit of the fine-ray-launch method may be further reduced because the benefits of the halo method and the fine-ray-launch method are not additive.

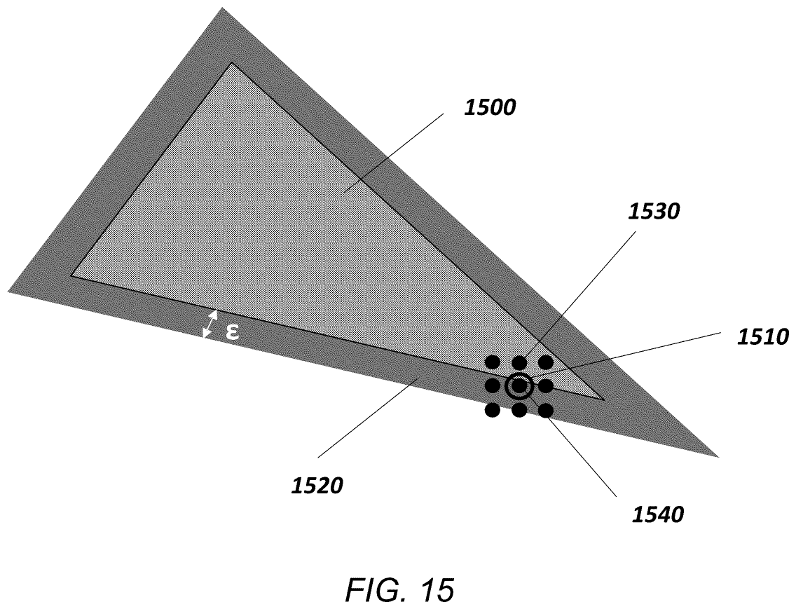

FIG. 15 shows an example of using a halo method and a fine-ray-launch method. More specifically, FIG. 15 shows an example of the overlapping effects of implementing both the halo method and the fine-ray-launch method. Voxelization of a TriSoup triangle 1500 may result in a voxel 1510 being added to a list of decoded voxels of a decoded point cloud, for example, because the voxel 1510 may be determined to belong to a halo 1520 around the TriSoup triangle 1500. Additionally or alternatively, voxelization of a TriSoup triangle 1500 may result in a voxel 1510 being added to a list of decoded voxels of a decoded point cloud, for example, because an extra ray 1530, launched relative to a first ray 1540 passing through the center of the voxel 1510, may intersect the triangle 1500. The voxel 1510 may be added twice, for example, if both the halo method and the fine-ray-launch method are used. This overlapping effect may be caused by both methods extending points to be voxelized along the plane of TriSoup triangle 1500. Extending the halo parameter ε and extending the distance of extra rays (e.g., fine rays) from a first ray may result, for example, in additional points along the plane of TriSoup triangle 1500 being determined.

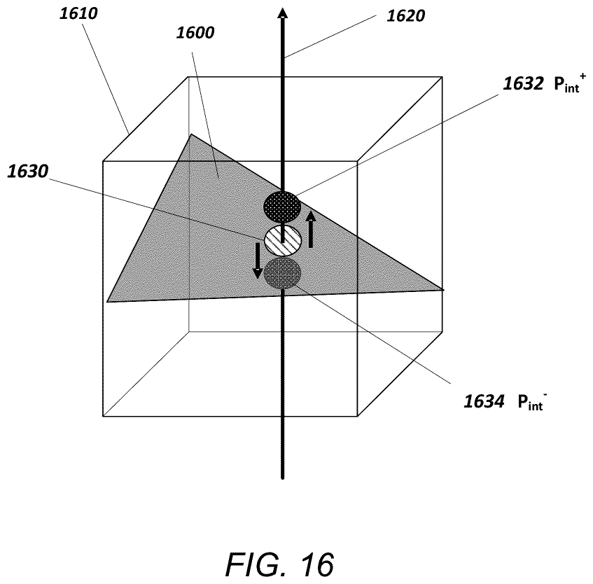

FIG. 16 shows an example of enhancing voxelization of a TriSoup triangle. More specifically, FIG. 16 shows an example of enhancing voxelization of a TriSoup triangle 1600 based on adding one or more points. The adding of the one or more points may be based on a point determined to be in the TriSoup triangle 1600. Enhancing voxelization in this way may be referred to as using (e.g., applying) a “thickness” of TriSoup triangles method. The point may be, for example, an intersection point between ray 1620 and the TriSoup Triangle 1600. The TriSoup triangle 1600 may belong to a cuboid 1610 corresponding to a TriSoup node. One or more points 1632 and/or 1634 may be determined, for example, based on a point 1630 in (e.g., within or on an edge of) the TriSoup triangle 1600, as described herein. A point determined to be in a TriSoup triangle (e.g., TriSoup triangle 1600) may refer to the point as being within or on an edge of the TriSoup triangle. One or more of points (e.g., point 1632 and/or point 1634) may be determined using the point 1630 but, for example, may not be on the same plane as the TriSoup triangle 1600 containing the point 1630. As described herein, by determining these one or more points (e.g., points 1632 and/or 1634) to be voxelized, processing complexity may not be increased, the fine-ray launch methods may be replaced, and the halo method may be enhanced without redundant effects.

Point 1630 may be an intersection point Pᵢₙₜ between a ray 1620 and a TriSoup triangle 1600. Ray 1620 may be launched, for example, from integral coordinates and in a direction that may be parallel to a coordinate axis (e.g., x-axis, y-axis, or z-axis) in 3D space. Rays 1620 may be launched, for example, along one or more coordinate axes in 3D space. Rays may be launched, for example, from one or more of the coordinate axes. Rays may be launched in order of coordinate axes that are determined to be most perpendicular to a plane of TriSoup triangle 1600. Rays (e.g., rays 1620) may be launched, for example, from at most two of the three coordinate axes that are determined to be most perpendicular or most parallel to a normal of a TriSoup triangle (e.g., TriSoup triangle 1600).

As described herein, an intersection may be determined based on computing barycentric coordinates (e.g., the Möller-Trumbore algorithm). A point 1630 may be voxelized (e.g., rounded and/or quantized to a closest voxel along ray 1620) and/or added to a list of decoded points, or voxels, of a decoded point cloud. One or more points (e.g., point 1632 and/or point 1634) may be determined from a point 1630. One or more points (e.g., point 1632 and/or point 1634) may be determined from a point 1630, for example, based on adding and/or subtracting a vector with a magnitude equal to a value (e.g., a thickness value t). A point 1634 (Pᵢₙₜ⁻) and/or a point 1632 (Pᵢₙₜ⁺) may be determined by subtracting and/or adding the vector with magnitude equal to t as follows:

$${P}_{int}^{\pm } = {P}_{int} \pm \vec{{n}_{ray}}$$

where \vec{n_{ray}} is a vector with a magnitude of τ. Point 1632 (Pᵢₙₜ⁺) may be indicated, for example, by point 1630 displaced by the value (e.g., distance) of t in a first direction of vector \vec{n_{ray}}. Point 1634 (Pᵢₙₜ⁻) may be indicated, for example, by point 1630 displaced by the value (e.g., distance) of τ in a second direction that may be opposite the first direction. The vector \vec{n_{ray}} may be parallel to ray 1620, and the ray 1620 may be launched parallel to a coordinate axis. In addition to point 1630, the two extra points (e.g., Pᵢₙₜ⁻ 1634 and Pᵢₙₜ⁺ 1632) may also be voxelized (e.g., quantized or rounded) and added to a list of decoded points (e.g., corresponding voxels) of the decoded point cloud. The voxelization of the three points (e.g., Pᵢₙₜ. 1630, Pᵢₙₜ⁺ 1632, and Pᵢₙₜ⁻ 1634) may result in the same voxelized decoded point, or voxel. The three points Pᵢₙₜ. 1630, Pᵢₙₜ⁺ 1632, and Pᵢₙₜ⁻ 1634 may be voxelized to at most two voxels, for example, based on the t value being smaller than a predetermined value (e.g., ¼).

Point Pᵢₙₜ⁻ 1634 and/or point Pᵢₙₜ⁺ 1632 may be determined by subtracting and/or adding a vector, with a magnitude equal to τ, that may be perpendicular to a TriSoup triangle 1600 as follows:

$${P}_{int}^{\pm } = {P}_{int} \pm \vec{{n}_{tri}}$$

where \vec{nₜᵣᵢ} is a vector that is perpendicular to the TriSoup triangle 1600 and has a magnitude of τ. Point Pᵢₙₜ 1630 may be determined, for example, by a voxelization method different from a ray tracing method. A rasterization method may be used, for example, where the TriSoup triangle 1600 may be converted to a triangle in 2D. Points of the triangle in 2D may be determined. The determined points of the 2D triangle may be projected back to 3D. Voxelization methods based on the digital differential analyzer (DDA) algorithm or the Bresenham algorithm may also be used.

A value τ may be a predetermined value (e.g., ⅛ of a size of voxel). The value τ may be defined relative to a size of voxel. The value τ may be a parameter (e.g., a “thickness” parameter) that may be determined by an encoder and may be signaled as an indication to a decoder.

One or two extended points may be determined. One or two extended points may be determined, for example, for each point (e.g., intersection point) determined in a TriSoup triangle 1600. The TriSoup triangle 1600 may be extended by two parallel planes of points and may be considered equivalent to replacing the TriSoup triangle 1600 by a prism of height 2τ. The TriSoup triangle 1600 may be extended by two parallel planes of points and may be considered equivalent to replacing the TriSoup triangle 1600 by a prism of height 2τ. for example, by determining a plurality of points in the TriSoup triangle 1600 that are above or below the points of the TriSoup triangle 1600 by a distance/value of τ. The prism may be an oblique prism, for example, if the two additional points Pᵢₙₜ⁻ and Pᵢₙₜ⁺ are obtained based on a vector \vec{n_{ray}} that is parallel to a ray 1620 that is not perpendicular to the TriSoup triangle 1600. The prism may be a right prism, for example, if the two additional points Pᵢₙₜ⁻ and Pᵢₙₜ⁺ are obtained based on the vector \vec{nₜᵣᵢ} that is perpendicular to the TriSoup triangle 1600. The height or the prism, therefore, may indicate a “thickness” of TriSoup triangle 1600. The value t, therefore, may also be referred to as a thickness parameter or a thickness value. Voxelization of the intersection of the ray with the prism may be equivalent to a method based on the voxelization of the three points Pᵢₙₜ. Pᵢₙₜ⁻ and Pᵢₙₜ⁺, for example, if the value τ is small.

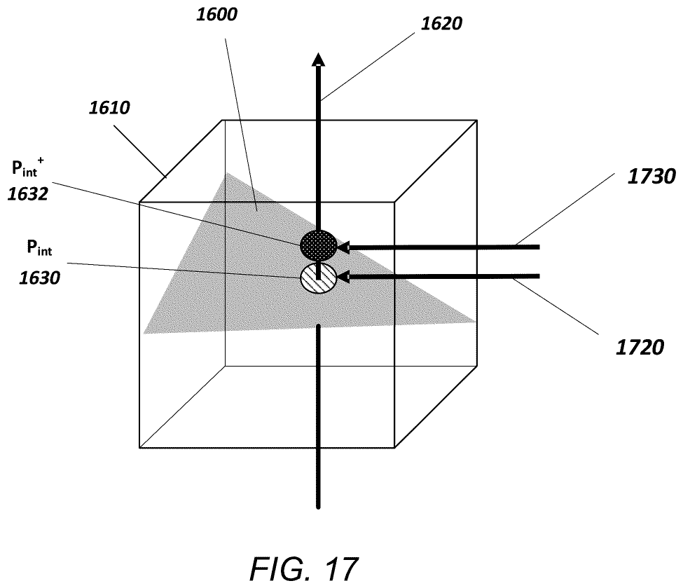

The fine-ray-launch method may be replaced by the method of using the “thickness” of TriSoup triangles, as described herein. FIG. 17 shows an example of enhancing voxelization of a TriSoup triangle. More specifically, FIG. 17 shows an example of how using the “thickness” of TriSoup triangles method may achieve similar results as launching fine rays. A point Pᵢₙₜ⁺ 1632 may be determined, for example, based on point Pᵢₙₜ 1630. As shown in FIG. 16, point Pᵢₙₜ 1630 indicates the intersection between a TriSoup triangle 1600 and a ray 1620 launched along a particular direction (e.g., a z coordinate axis). As shown in FIG. 16, the same intersection point Pᵢₙₜ 1630 may be determined based on a perpendicular ray 1720, perpendicular to the ray 1620, that is launched horizontally (e.g., a y-coordinate axis). The fine-ray-launch method may launch an additional perpendicular ray 1730 parallel to the perpendicular ray 1720 and perpendicular to the ray 1620. The perpendicular ray 1730 may determine the same intersection point Pᵢₙₜ⁺ 1632, determined based on point 1630 using a value τ (e.g., “thickness”), for example, if the distance between the perpendicular ray 1720 and the additional perpendicular ray 1730 is equal to the value t. Using the “thickness” of TriSoup triangles method to add one or more additional points may, advantageously, replace the fine-ray-launch method because no extra rays need to be launched, resulting in a less computationally intensive process. Moreover, this using the “thickness” of TriSoup triangles method may be combined with the halo method, which operates on the plane containing the TriSoup triangle, since the additional one or more points are not added along the plane of the TriSoup triangle. In contrast, the benefits of the fine-ray-launch method are reduced when combined with the halo technique because both methods have an effect in the plane containing the TriSoup triangle.

A parameter for a value τ and/or the base halo parameters ε may be predetermined. A parameter for a value τ and/or the base halo parameters ε may, for example, be fixed in the specification of a codec. The parameter for the value τ and/or the base halo parameters ε may depend on properties of the original point cloud. The parameter for the value τ and/or the base halo parameters ε may be determined, for example, by an encoder and/or sent to a decoder. The parameter for the value τ and/or the base halo parameters ε may be encoded into a bitstream and/or decoded by a decoder.

A parameter for a value τ and/or base halo parameters ε may be encoded into a bitstream, for example, at a sequence level (e.g., into Sequence Parameter Set [SPS]), at a frame level (e.g., into a Geometry Parameter Set [GPS]), and/or at a more local level. The parameter for a value τ and/or the base halo parameters ε may be encoded per slice or per brick into a Geometry Brick Header (GBH), for example, at a more local level.

An encoder may signal an activation flag indicating, for example, whether a proposed mechanism based on a value τ is to be performed by a decoder in voxelizing a TriSoup triangle. An encoder may signal an activation flag indicating, for example, whether a proposed mechanism based on a value τ is not to be performed by a decoder in voxelizing a TriSoup triangle. The activation flag may be encoded into a SPS, a GPS, and/or a GBH. The decoder may receive and/or decode the activation flag from a bitstream.

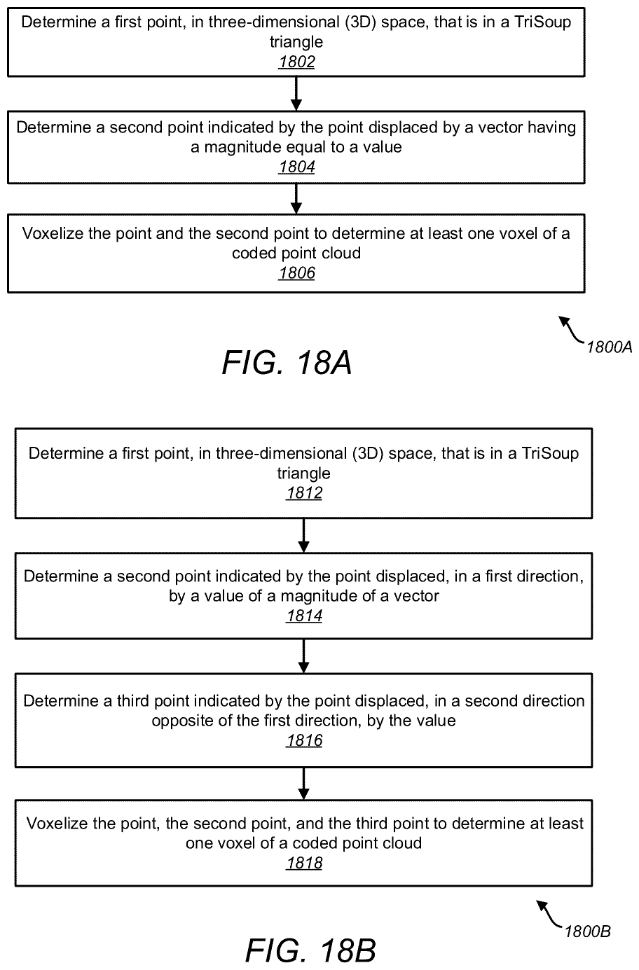

FIG. 18A shows an example method of coding (e.g., encoding and/or decoding) a point cloud from TriSoup triangles. More specifically, FIG. 18A shows a flowchart 1800A of example method steps for coding a point cloud from TriSoup triangles. One or more steps of the example flowchart 1800A may be implemented by a decoder and/or an encoder (e.g., a decoder 120 and/or an encoder 114 as described herein with respect to FIG. 1). At step 1802 of FIG. 18A, a decoder and/or an encoder may determine a first point that may be in a TriSoup triangle. The first point may be in a three-dimensional (3D) space. A point being in a TriSoup triangle may comprise being on an edge of the TriSoup triangle or within (e.g., inside) the TriSoup triangle bounded by the edges of the TriSoup triangle. The TriSoup triangle may comprise three vertices with at least two being along two TriSoup edges of a cuboid corresponding to a TriSoup node (e.g., as described herein with respect to FIGS. 8, 9, and 16.) Examples of TriSoup triangles are shown in 3D with respect to FIG. 8, FIG. 9, and FIG. 16.

The first point may be determined to be at a ray-triangle intersection point. The first point may be determined to be at a ray-triangle intersection point, for example, based on using a ray casting or ray tracing algorithm (e.g., the Möller-Trumbore algorithm). The first point may be determined to be in the TriSoup triangle, for example, based on determining the point is at an intersection point between the TriSoup triangle and a ray extended parallel to a coordinate axis in the 3D space (e.g., one of an x-axis, a y-axis, or a z-axis of the 3D space). The decoder and/or the encoder may convert coordinates of the three TriSoup vertices of the TriSoup triangle to barycentric coordinates, for example, to determine an intersection point between the TriSoup triangle and the ray. The intersection point may be determined, for example, based on using (e.g., applying) the Möller-Trumbore algorithm using three vertices of the TriSoup triangle and the ray, as described herein with respect to FIG. 11. To determine an intersection point between the TriSoup triangle and the ray extended parallel to a coordinate axis, rays may be launched from a ray, or extended from a ray, having an origin at integral coordinates. The ray may be extended or launched in a direction that may be toward the inside of a cuboid (e.g., as corresponding to the TriSoup node) containing the TriSoup triangle.

The first point may be determined based on a rasterization or related methods. The related methods may include, for example, a digital differential analyzer (DDA) algorithm or a Bresenham algorithm. A decoder and/or an encoder may perform rasterization, for example, by converting a TriSoup triangle into a triangle in 2D space. The decoder and/or the encoder may determine a 2D point (e.g., pixel), for example, that is in the 2D triangle (e.g., on an edge or within the 2D triangle bounded by the edges). The decoder and/or the encoder may project the 2D point to 3D space to determine the first point, for example, after the decoder and/or the encoder determines the 2D point. The first point in the TriSoup triangle may correspond, for example, to the 2D point projected to 3D space. The first point and/or the 2D point may be determined, for example, based on using a DDA algorithm, a Bresenham algorithm, etc.

At step 1804 of FIG. 18A, the decoder and/or the encoder may determine a second point. The second point may be determined, for example, as a point that is displaced by a vector having a magnitude equal to a value (e.g., t) from the first point. The second point may be outside of the TriSoup triangle. The second point may not belong to a plane of the TriSoup triangle.

A point may be determined as an intersection between a ray and the TriSoup triangle (e.g., as described with respect to step 1802). A vector may be parallel to a ray, and the ray may be parallel to a coordinate axis in the 3D space. The vector may be perpendicular to a plane of the TriSoup triangle. This type of vector may be determined based on a rasterization approach. of the vector may be used, for example, based on the intersection point being determined using ray tracing or ray casting.

A value (e.g., t) may be predetermined. The value τ may be defined relative to a size of a voxel (e.g., ⅛, ¼, 1/16, etc., of a size of a voxel). The value may be ⅛ of a size of a voxel, for example, to achieve similar performance as a fine-ray-launch method with reduced computation costs. A decoder and/or an encoder may receive an indication (e.g., a syntax element) that may indicate the value.

At step 1806 of FIG. 18A, the decoder and/or the encoder may voxelize the first point and the second point. The decoder and/or encoder may voxelize the first point and the second point, for example, to determine at least one voxel of a decoded point cloud. The first point and the second point may be voxelized, for example, to at most two voxels of a decoded point cloud. The at least one voxel may be at most two voxels (e.g., two different voxels) of the decoded point cloud. Voxelizing the first point and the second point may include quantizing, and/or rounding, the first point and the second point to a first voxel and a second voxel, respectively.

Voxelizing a first point and a second point may include voxelizing the first point to determine a first voxel and voxelizing the second point to determine a second voxel. The at least one voxel may include at least one of the first voxel and/or the second voxel. The at least one voxel may include one of the first voxel or the second voxel, for example, if the first voxel and the second voxel are the same. The at least one voxel may include both the first voxel and the second voxel, for example, if the first voxel and the second voxel are different.

The first voxel (e.g., a corresponding first decoded voxelized point) and the second voxel (e.g., a corresponding second decoded voxelized point) may be added to a list of rendered voxels (e.g., decoded voxelized points). The decoder and/or the encoder may remove duplicate voxels from the list of rendered voxels to represent a decoded point cloud, if any duplicates exist.

One or more additional points may be determined based on the first point determined at step 1802. A second point may be determined based on a first point, for example, by adding a vector to the first point. Similarly, a third point may be determined based on the first point, for example, by subtracting the vector from the first point (e.g., as described herein with respect to FIG. 16). The first point, the second point, and the third point may be voxelized. The first point, the second point, and the third point may be voxelized, for example, to determine at least one voxel of a decoded point cloud. The first point, the second point, and the third point may be voxelized, for example, to at most two voxels of a decoded point cloud.

A second point may be indicated as a point displaced from a first point by a value in a first direction of a vector. A decoder and/or an encoder may determine a third point indicated as the point displaced from the first point by the value in a second direction that may be opposite of the first direction. The first point, the second point, and the third point may be voxelized to determine at least one voxel of a decoded point cloud. The first point, the second point, and the third point may be voxelized to at most two voxels of a decoded point cloud. The first direction and/or the second direction may be parallel to a coordinate axis in a 3D space. The first direction and/or the second direction may be perpendicular to a plane of the TriSoup triangle (e.g., parallel to a normal of the TriSoup triangle).

A decoder and/or an encoder may determine an intersection point between a TriSoup triangle and a ray extended parallel to a coordinate axis in a 3D space (e.g., as described herein with respect to FIG. 16). The decoder and/or the encoder may determine a point indicated as the intersection point by a vector, displaced parallel to the ray, and comprising a magnitude equal to a value. The value (e.g., the value t) may be a predetermined value (e.g., ⅛ the size of a voxel). The value may be indicated by a signal received and/or decoded from a bitstream. The decoder and/or the encoder may voxelize the intersection point and/or the second point to determine at least one voxel of a decoded point cloud. The at least one voxel may be at most two voxels of the decoded point cloud.

FIG. 18B shows an example method of coding (e.g., encoding and/or decoding) a point cloud from TriSoup triangles. More specifically, FIG. 18B shows a flowchart 1800B of example method steps for decoding a point cloud from TriSoup triangles. One or more steps of the example flowchart 1800B may be implemented by a decoder and/or an encoder (e.g., a decoder 120 and/or an encoder 114 as described herein with respect to FIG. 1). Two or more additional points may be determined for each point determined in a TriSoup triangle, for example, as described herein with respect to FIG. 18A. At step 1812 of FIG. 18B, a decoder and/or an encoder may determine a first point, in a 3D space, that may be in a TriSoup triangle. The first point may be determined as an intersection between a ray, parallel to a coordinate axis, and the TriSoup triangle. At step 1814 of FIG. 18B, the decoder and/or the encoder may determine a second point to be a point displaced, in a first direction, by a value of a magnitude of a vector. The value may be a predetermined value and/or received as an indication in a bitstream. At step 1816 of FIG. 18B, the decoder and/or the encoder may determine a third point to be a point displaced, in a second direction, that may be opposite the first direction, by the value of the magnitude of the vector. At step 1818 of FIG. 18B, the decoder and/or the encoder may voxelize the first point, the second point, and the third point to determine at least one voxel of a decoded point cloud.

Although FIG. 18A and FIG. 18B may be described with respect to one determined point (e.g., an intersection point) in a TriSoup triangle, a plurality of such points in the TriSoup triangle may be determined by the decoder and/or the encoder. A ray-triangle intersection method may be used to determine points of intersection between a plurality of rays and the TriSoup triangle. Additionally, although FIG. 18A and FIG. 18B may be described with respect to extending and/or launching rays in one coordinate axis, a plurality of rays may be launched from more than one coordinate axis and/or set of coordinate axis, and multiple points of intersection may be determined between the plurality of rays and the TriSoup triangle.

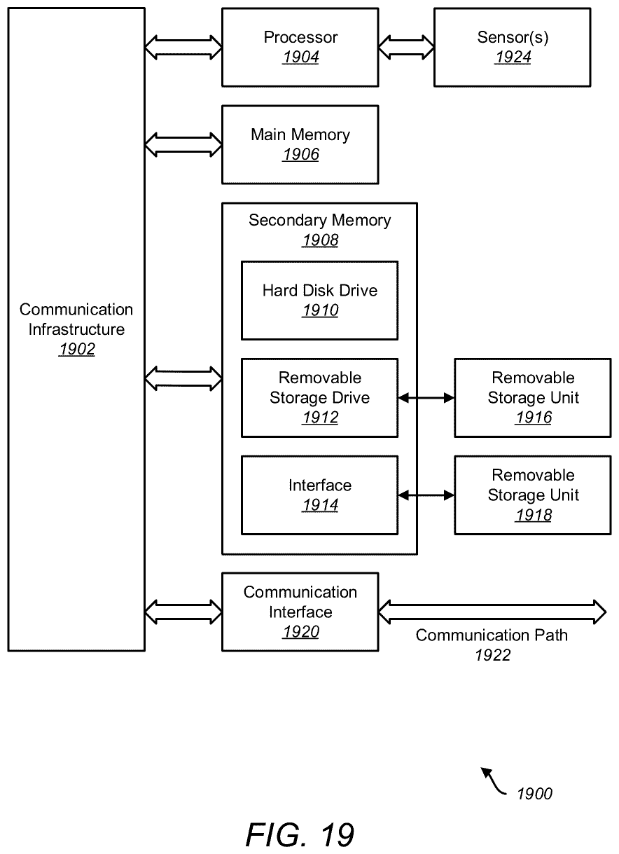

FIG. 19 shows an example computer system in which examples of the present disclosure may be implemented. For example, the example computer system 1900 shown in FIG. 19 may implement one or more of the methods described herein. For example, various devices and/or systems described herein (e.g., in FIGS. 1, 2, and 3) may be implemented in the form of one or more computer systems 1900. Furthermore, each of the steps of the flowcharts depicted in this disclosure may be implemented on one or more computer systems 1900.

The computer system 1900 may comprise one or more processors, such as a processor 1904. The processor 1904 may be a special purpose processor, a general purpose processor, a microprocessor, and/or a digital signal processor. The processor 1904 may be connected to a communication infrastructure 1902 (for example, a bus or network). The computer system 1900 may also comprise a main memory 1906 (e.g., a random access memory (RAM)), and/or a secondary memory 1908.

The secondary memory 1908 may comprise a hard disk drive 1910 and/or a removable storage drive 1912 (e.g., a magnetic tape drive, an optical disk drive, and/or the like). The removable storage drive 1912 may read from and/or write to a removable storage unit 1916. The removable storage unit 1916 may comprise a magnetic tape, optical disk, and/or the like. The removable storage unit 1916 may be read by and/or may be written to the removable storage drive 1912. The removable storage unit 1916 may comprise a computer usable storage medium having stored therein computer software and/or data.

The secondary memory 1908 may comprise other similar means for allowing computer programs or other instructions to be loaded into the computer system 1900. Such means may include a removable storage unit 1918 and/or an interface 1914. Examples of such means may comprise a program cartridge and/or cartridge interface (such as in video game devices), a removable memory chip (such as an erasable programmable read-only memory (EPROM) or a programmable read-only memory (PROM)) and associated socket, a thumb drive and USB port, and/or other removable storage units 1918 and interfaces 1914 which may allow software and/or data to be transferred from the removable storage unit 1918 to the computer system 1900.

The computer system 1900 may also comprise a communications interface 1920. The communications interface 1920 may allow software and data to be transferred between the computer system 1900 and external devices. Examples of the communications interface 1920 may include a modem, a network interface (e.g., an Ethernet card), a communications port, etc. Software and/or data transferred via the communications interface 1920 may be in the form of signals which may be electronic, electromagnetic, optical, and/or other signals capable of being received by the communications interface 1920. The signals may be provided to the communications interface 1920 via a communications path 1922. The communications path 1922 may carry signals and may be implemented using wire or cable, fiber optics, a phone line, a cellular phone link, an RF link, and/or any other communications channel(s).

A computer program medium and/or a computer readable medium may be used to refer to tangible storage media, such as removable storage units 1916 and 1918 or a hard disk installed in the hard disk drive 1910. The computer program products may be means for providing software to the computer system 1900. The computer programs (which may also be called computer control logic) may be stored in the main memory 1906 and/or the secondary memory 1908. The computer programs may be received via the communications interface 1920. Such computer programs, when executed, may enable the computer system 1900 to implement the present disclosure as discussed herein. In particular, the computer programs, when executed, may enable the processor 1904 to implement the processes of the present disclosure, such as any of the methods described herein. Accordingly, such computer programs may represent controllers of the computer system 1900.

Features of the disclosure may be implemented in hardware using, for example, hardware components such as application-specific integrated circuits (ASICs) and gate arrays. Implementation of a hardware state machine to perform the functions described herein will also be apparent to persons skilled in the relevant art(s).

FIG. 20 shows example elements of a computing device that may be used to implement any of the various devices described herein, including, for example, a source device (e.g., 102), an encoder (e.g., 200), a destination device (e.g., 106), a decoder (e.g., 300), and/or any computing device described herein. The computing device 2030 may include one or more processors 2031, which may execute instructions stored in the random-access memory (RAM) 2033, the removable media 2034 (such as a Universal Serial Bus (USB) drive, compact disk (CD) or digital versatile disk (DVD), or floppy disk drive), or any other desired storage medium. Instructions may also be stored in an attached (or internal) hard drive 2035. The computing device 2030 may also include a security processor (not shown), which may execute instructions of one or more computer programs to monitor the processes executing on the processor 2031 and any process that requests access to any hardware and/or software components of the computing device 2030 (e.g., ROM 2032, RAM 2033, the removable media 2034, the hard drive 2035, the device controller 2037, a network interface 2039, a GPS 2041, a Bluetooth interface 2042, a WiFi interface 2043, etc.). The computing device 2030 may include one or more output devices, such as the display 2036 (e.g., a screen, a display device, a monitor, a television, etc.), and may include one or more output device controllers 2037, such as a video processor. There may also be one or more user input devices 2038, such as a remote control, keyboard, mouse, touch screen, microphone, etc. The computing device 2030 may also include one or more network interfaces, such as a network interface 2039, which may be a wired interface, a wireless interface, or a combination of the two. The network interface 2039 may provide an interface for the computing device 2030 to communicate with a network 2040 (e.g., a RAN, or any other network). The network interface 2039 may include a modem (e.g., a cable modem), and the external network 2040 may include communication links, an external network, an in-home network, a provider's wireless, coaxial, fiber, or hybrid fiber/coaxial distribution system (e.g., a DOCSIS network), or any other desired network. Additionally, the computing device 2030 may include a location-detecting device, such as a global positioning system (GPS) microprocessor 2041, which may be configured to receive and process global positioning signals and determine, with possible assistance from an external server and antenna, a geographic position of the computing device 2030.

The example in FIG. 20 may be a hardware configuration, although the components shown may be implemented as software as well. Modifications may be made to add, remove, combine, divide, etc. components of the computing device 2030 as desired. Additionally, the components may be implemented using basic computing devices and components, and the same components (e.g., processor 2031, ROM storage 2032, display 2036, etc.) may be used to implement any of the other computing devices and components described herein. For example, the various components described herein may be implemented using computing devices having components such as a processor executing computer-executable instructions stored on a computer-readable medium, as shown in FIG. 20. Some or all of the entities described herein may be software based, and may co-exist in a common physical platform (e.g., a requesting entity may be a separate software process and program from a dependent entity, both of which may be executed as software on a common computing device).

A computing device may perform a method comprising multiple operations. The computing device may determine a first point, in a three-dimensional (3D) space, that may be within a TriSoup triangle. The computing device may determine a second point that may be displaced from the first point by a vector. The computing device may determine at least one voxel, of a set of voxels representing a point cloud, for example, by voxelizing the first point and the second point. The point cloud may comprise a decoded point cloud. The first point may be associated with a point cloud video. The computing device may decode a video. The video may comprise a sequence of point clouds. The first point being within the TriSoup triangle may comprise the point being on an edge of the TriSoup triangle or being within the TriSoup triangle. The second point may be outside of the TriSoup triangle. The TriSoup triangle may comprise three vertices, and at least two of the three vertices may be along two TriSoup edges of a cuboid associated with a TriSoup node. Determining that a first point may be within a TriSoup triangle may comprise determining that the first point may be at a point of intersection between the TriSoup triangle and a ray extended parallel to a coordinate axis in the 3D space. The TriSoup triangle may comprise three vertices. The first point may be determined using the Möller-Trumbore algorithm with the three vertices of the TriSoup triangle and the ray. Determining the first point may comprise converting the TriSoup triangle into a triangle in 2D space, determining a 2D point that may be in the triangle, and projecting the 2D point to a 3D space. Determining at least one voxel may comprise voxelizing the first point to determine a first voxel and voxelizing the second point to determine a second voxel, and at least one voxel may comprise at least one of the first voxel and/or the second voxel. The first point and/or the second point may be voxelized to at most two voxels of the point cloud. The vector may have a magnitude equal to a predetermined value. The wireless device may receive an indication of a value, and the vector may have a magnitude equal to the value. The second point may be determined based on adding the vector to the first point. The computing device may further determine a third point based on subtracting the vector from the first point. The voxelizing may comprise voxelizing the first point, the second point, and the third point, for example, to determine the at least one voxel of the point cloud. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to encode a point cloud. A computer-readable medium may store instructions that, when executed, cause performance of the described method, additional operations and/or include the additional elements.

A computing device may perform a method comprising multiple operations. The computing device may determine a first point, in a three-dimensional (3D) space, that may be within a TriSoup triangle. The computing device may determine a second point that may be displaced from the first point by a vector, and the computing device may determine at least one voxel by voxelizing the first point and the second point. A set of voxels, including the at least one voxel, may represent a point cloud. The first point, the second point, and a third point may be voxelized to at most two voxels of a point cloud. The at least one voxel may comprise one of the first voxel and the second voxel, for example, if the first voxel and the second voxel are the same. Alternatively, the at least one voxel may comprise both the first voxel and the second voxel, for example, if the first voxel and the second voxel are different. The vector may be perpendicular to a plane associated with the TriSoup triangle. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to encode a point cloud. A computer-readable medium may store instructions that, when executed, cause performance of the described method, additional operations and/or include the additional elements.

A computing device may perform a method comprising multiple operations. The computing device may determine a first point as a point of intersection between a TriSoup triangle and a ray that may be extended parallel to a coordinate axis of a three-dimensional (3D) space. The computing device may determining a second point that may be displaced from the first point by a vector that may be parallel to the ray. The computing device may determine at least one voxel, of a set of voxels representing a coded point cloud, for example, by voxelizing the first point and the second point. An intersection of the ray and a plane of the TriSoup triangle may be represented as barycentric coordinates that may be relative to the TriSoup triangle, and the first point may be determined based on the barycentric coordinates. The second point may be determined based on adding the vector to the first point, and the computing device may further determine a third point based on subtracting the vector from the first point. Determining the first point may be based on using one of a digital differential analyzer (DDA) algorithm or a Bresenham algorithm. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to encode a point cloud. A computer-readable medium may store instructions that, when executed, cause performance of the described method, additional operations and/or include the additional elements.

A computing device may perform a method comprising multiple operations. The computing device may determine a first point, in a three-dimensional (3D) space, that may be inside a TriSoup triangle. The computing device may determine a second point that is displaced from the first point by a vector, and the computing device may determine at least one voxel of a decoded point cloud, for example, by voxelizing the first point and the second point. The TriSoup triangle may comprise three vertices. The TriSoup triangle may belong to a TriSoup node. The vector and the ray may be parallel. The coordinate axis that may be in the 3D space may comprise an x-coordinate axis, a y-coordinate axis, and a z-coordinate axis. The ray may be extended in a direction that may be towards the inside of a cuboid containing the TriSoup triangle. The computing device may add the first voxel and the second voxel to a list of rendered voxels, and the computing device may remove one or more duplicate voxels from the list of rendered voxels. Voxelizing the first point and the second point may comprise quantizing the first point and the second point to a first voxel and a second voxel, respectively. The vector may have a magnitude that may be equal to a predetermined value. The value may be ⅛ of a size of a voxel. The first direction and the second direction may both be parallel to a coordinate axis in the 3D space. The first direction and the second direction may both be perpendicular to a plane of the TriSoup triangle. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to encode a point cloud. A computer-readable medium may store instructions that, when executed, cause performance of the described method, additional operations and/or include the additional elements.

One or more examples herein may be described as a process which may be depicted as a flowchart, a flow diagram, a data flow diagram, a structure diagram, and/or a block diagram. Although a flowchart may describe operations as a sequential process, one or more of the operations may be performed in parallel or concurrently. The order of the operations shown may be re-arranged. A process may be terminated when its operations are completed, but could have additional steps not shown in a figure. A process may correspond to a method, a function, a procedure, a subroutine, a subprogram, etc. If a process corresponds to a function, its termination may correspond to a return of the function to the calling function or the main function.

Operations described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks. Features of the disclosure may be implemented in hardware using, for example, hardware components such as application-specific integrated circuits (ASICs) and gate arrays. Implementation of a hardware state machine to perform the functions described herein will also be apparent to persons skilled in the art.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein. Computer-readable medium may comprise, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

A non-transitory tangible computer readable media may comprise instructions executable by one or more processors configured to cause operations described herein. An article of manufacture may comprise a non-transitory tangible computer readable machine-accessible medium having instructions encoded thereon for enabling programmable hardware to cause a device (e.g., an encoder, a decoder, a transmitter, a receiver, and the like) to allow operations described herein. The device, or one or more devices such as in a system, may include one or more processors, memory, interfaces, and/or the like.

Communications described herein may be determined, generated, sent, and/or received using any quantity of messages, information elements, fields, parameters, values, indications, information, bits, and/or the like. While one or more examples may be described herein using any of the terms/phrases message, information element, field, parameter, value, indication, information, bit(s), and/or the like, one skilled in the art understands that such communications may be performed using any one or more of these terms, including other such terms. For example, one or more parameters, fields, and/or information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more of the operations described herein may be conditional. For example, one or more operations may be performed if certain criteria are met, such as in computing device, a communication device, an encoder, a decoder, a network, a combination of the above, and/or the like. Example criteria may be based on one or more conditions such as device configurations, traffic load, initial system set up, packet sizes, traffic characteristics, a combination of the above, and/or the like. If the one or more criteria are met, various examples may be used. It may be possible to implement any portion of the examples described herein in any order and based on any condition.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

What is claimed is:

1. A method comprising:
determining a first point, in a three-dimensional (3D) space, that is within a TriSoup triangle;
determining a second point that is displaced from the first point by a vector; and
determining at least one voxel, of a set of voxels representing a point cloud, by voxelizing the first point and the second point.

2. The method of claim 1, wherein the point cloud comprises a decoded point cloud.

3. The method of claim 1, wherein the first point being within the TriSoup triangle comprises the point:
being on an edge of the TriSoup triangle; or
being within the TriSoup triangle.

4. The method of claim 1, wherein the second point is outside of the TriSoup triangle.

5. The method of claim 1, wherein the TriSoup triangle comprises three vertices, and wherein at least two of the three vertices are along two TriSoup edges of a cuboid associated with a TriSoup node.

6. The method of claim 1, wherein the determining the first point that is within the TriSoup triangle comprises:
determining that the first point is at a point of intersection between the TriSoup triangle and a ray extended parallel to a coordinate axis in the 3D space.

7. The method of claim 1, wherein the TriSoup triangle comprises three vertices; and
wherein the first point is determined using the Möller-Trumbore algorithm with the three vertices of the TriSoup triangle and the ray.

8. The method of claim 1, wherein the determining at least one voxel comprises:
voxelizing the first point to determine a first voxel;
voxelizing the second point to determine a second voxel; and
wherein the at least one voxel comprises at least one of the first voxel and the second voxel.

9. The method of claim 1, wherein the first point and the second point are voxelized to at most two voxels of the point cloud.

10. The method of claim 1, wherein the vector has a magnitude equal to a predetermined value.

11. The method of claim 1, further comprising receiving an indication of a value, wherein the vector has a magnitude equal to the value.

12. The method of claim 1, wherein the second point is determined based on adding the vector to the first point; and further comprising:
determining a third point based on subtracting the vector from the first point; and
wherein the voxelizing comprises voxelizing the first point, the second point, and the third point to determine the at least one voxel of the decoded point cloud.

13. A method comprising:
determining a first point, in a three-dimensional (3D) space, that is within a TriSoup triangle;
determining a second point that is displaced from the first point by a vector; and
determining at least one voxel by voxelizing the first point and the second point.

14. The method of claim 13, wherein a set of voxels, including the at least one voxel, represent a point cloud.

15. The method of claim 13, wherein the first point, the second point, and a third point are voxelized to at most two voxels of a point cloud.

16. The method of claim 13, wherein the at least one voxel comprises:
one of the first voxel and the second voxel if the first voxel and the second voxel are the same; and
both the first voxel and the second voxel if the first voxel and the second voxel are different.

17. A method comprising:
determining a first point as a point of intersection between a TriSoup triangle and a ray extended parallel to a coordinate axis of a three-dimensional (3D) space;
determining a second point that is displaced from the first point by a vector parallel to the ray; and
determining at least one voxel, of a set of voxels representing a coded point cloud, by voxelizing at least one of the first point and the second point.

18. The method of claim 17, wherein an intersection of the ray and a plane of the TriSoup triangle is represented as barycentric coordinates relative to the TriSoup triangle, and wherein the first point is determined based on the barycentric coordinates.

19. The method of claim 17, wherein the second point is determined based on adding the vector to the first point, and wherein the method further comprises:
determining a third point based on subtracting the vector from the first point.

20. The method of claim 17, wherein the determining the first point is based on using one of a digital differential analyzer (DDA) algorithm or a Bresenham algorithm.
